(19) United States
(12) Patent Application Publication
(10) Pub. No.: US 2013/0339433 A1
(43) Pub. Date: Dec. 19, 2013

(54) METHOD AND APPARATUS FOR CONTENT RATING USING REACTION SENSING

(71) Applicants: Kevin Ansia Li, Chatham, NJ (US); Alex Varshavsky, East Hanover, NJ (US); Xuan Bao, Durham, NC (US); Romit Roy Choudhury, Durham, NC (US); Songchun Fan, Durham, NC (US)

(72) Inventors: Kevin Ansia Li, Chatham, NJ (US); Alex Varshavsky, East Hanover, NJ (US); Xuan Bao, Durham, NC (US); Romit Roy Choudhury, Durham, NC (US); Songchun Fan, Durham, NC (US)

(73) Assignees: Duke University, Durham, NC (US); AT&T Intellectual Property I, LP, Atlanta, GA (US)

(21) Appl. No.: 13/523,927

(22) Filed: Jun. 15, 2012

(51) Int. Cl. G06F 15/16

(52) U.S. Cl. 709/204

(57) ABSTRACT

A system that incorporates teachings of the subject disclosure may include, for example, receiving segment ratings and semantic labels associated with media content from a group of first communication devices, analyzing the segment ratings and the semantic labels to identify universal segments among the plurality of segments that satisfy a threshold based on common segment ratings and common semantic labels; and providing universal reactions and an identification of the universal segments to a second communication device for generation of a content rating for the media content based on the universal segments and reaction data collected by sensors of the second communication device, where the universal reactions are representative of the common segment ratings and the common semantic labels for the universal segments. Other embodiments are disclosed.

### FIELD OF THE DISCLOSURE

The subject disclosure relates to rating of media content, and in particular, a method and apparatus for content rating using reaction sensing.

### BACKGROUND

As more media content becomes available to larger audiences, summaries and ratings of the content can be helpful in determining which content to consume. Eliciting information from users that enables accurate ratings and summaries of media content can be difficult, partly due to the lack of incentives.

Providing a brief review of media content can take up a good amount of the user's time. Reviews that try to use a limited amount of time of the reviewer often are unable to extract the detailed information needed to more accurately summarize and rate media content.

### BRIEF DESCRIPTION OF THE DRAWINGS

Reference will now be made to the accompanying drawings, which are not necessarily drawn to scale, and wherein:

FIG. 1 depicts an illustrative embodiment of a content rating generated by a rating system;

FIG. 2 depicts an illustrative embodiment of a communication system that provides media services including content rating;

FIG. 3 depicts an illustrative embodiment of a process flow between modules and components of the communication system of FIG. 2;

FIG. 4 depicts image output utilized by an exemplary process for determining user reaction in the communication system of FIG. 2;

FIGS. 5-23 illustrate graphical representations, results and other information associated with an exemplary process performed using the communication system of FIG. 2;

FIG. 24 depicts an illustrative embodiment of a content rating generated by the communication system of FIG. 2;

FIG. 25 depicts an illustrative embodiment of a communication system that provides media services including content rating;

FIG. 26 depicts an illustrative embodiment of a communication device utilized in the communication systems of FIGS. 2 and 25; and

FIG. 27 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments of applying personal sensing and machine learning to enable machines to identify human behavior. One or more of the exemplary embodiments can automatically rate content on behalf of human users based on sensed reaction data. Device sensors, such as cameras, microphones, accelerometers, and gyroscopes, can be leveraged to sense qualitative human reactions while the user is consuming media content (e.g., a movie, other video content, video games, images, audio content, and so forth); learn how these qualitative reactions translate to a quantitative value; and visualize these learnings in an easy-to-read format. The collected reaction data can be mapped to segments of the presented media content, such as through time stamping or other techniques. In one or more exemplary embodiments, media content can automatically be tagged not only by a conventional star rating, but also with a tag-cloud of user reactions, as well as highlights of the content for different emotions.

One or more of the exemplary embodiments can extract the most relevant portions of the content for the content highlights, where the relevancy is determined by the users based on their user reactions. Reference to a particular type of sensor throughout this disclosure is an example of a sensor that can collect data, and the exemplary embodiments can apply the techniques described herein utilizing other sensors, including combinations of sensors, to collect various types of data that can be used for determining or otherwise inferring user reactions to the presentation of the media content. Other embodiments can be included in the subject disclosure.

One embodiment of the subject disclosure is a method including receiving, by a processor of a communication device, an identification of target segments selected from a plurality of segments of media content. The method includes receiving, by the processor, target reactions for the target segments, wherein the target reactions are based on a threshold correlation of reactions captured at other communication devices during the presentation of the media content. The method includes presenting, by the processor, the target segments and remaining segments of the plurality of segments of the media content at a display. The method includes obtaining, by the processor, first reaction data from sensors of the communication device during the presentation of the target segments of the media content, wherein the first reaction data comprises user images and user audio recordings, and wherein the first reaction data is mapped to the target segments. The method includes determining, by the processor, first user reactions for the target segments based on the first reaction data. The method includes generating, by the processor, a reaction model based on the first user reactions and the target reactions. The method includes obtaining, by the processor, second reaction data from the sensors of the communication device during the presentation of the remaining segments of the media content, wherein the second reaction data is mapped to the remaining segments. The method includes determining, by the processor, second user reactions for the remaining segments based on the second reaction data. The method includes generating, by the processor, segment ratings for the remaining segments based on the second user reactions and the reaction model.

One embodiment of the subject disclosure includes a communication device having a memory storing computer instructions, sensors, and a processor coupled with the memory and the sensors. The processor, responsive to executing the computer instructions, performs operations including accessing media content, accessing duty-cycle instructions that indicate a portion of the media content for which data collection is to be performed, presenting the media content, and obtaining reaction data utilizing the sensors during presentation of the portion of the media content. The operations also include detecting whether the communication device is receiving power from an external source or whether the communication device is receiving the power from only a battery, and obtaining the reaction data utilizing the sensors during presentation of a remaining portion of the media content responsive to a determination that the communication device is receiving the power from the external source. The operations also include ceasing data collection by the sensors during presentation of the remaining portion of the media content responsive to a determination that the communication device is receiving the power only from the battery, where the reaction data is mapped to the media content.

One embodiment of the subject disclosure includes a non-transitory computer-readable storage medium comprising computer instructions which, responsive to being executed by a processor, cause the processor to perform operations comprising receiving segment ratings and semantic labels associated with media content from a group of first communication devices, wherein each of the segment ratings and the semantic labels are mapped to a plurality of segments of the media content that were presented on the group of first communication devices. The operations also include analyzing the segment ratings and the semantic labels to identify target segments among the plurality of segments that satisfy a threshold based on common segment ratings and common semantic labels. The operations also include providing target reactions and an identification of the target segments to a second communication device for generation of a content rating for the media content based on the target segments and reaction data collected by sensors of the second communication device, wherein the target reactions are representative of the common segment ratings and the common semantic labels for the target segments.

One or more of the exemplary embodiments can rate or otherwise critique media content at multiple granularities. The type of media content can vary and can include, movies, videos, images, video games, audio and so forth. The source of the content can vary and can include, media sources (e.g., broadcast or video-on-demand programming or movies), personal sources (e.g., personal content including images or home-made videos), and so forth. Reference to a movie or video content throughout this disclosure is one example of the media content, and the exemplary embodiments can apply the techniques described herein and utilize the devices described herein on other forms of media content including combinations of media content. As an example, communication devices, such as smartphones or tablets, can be equipped with sensors, which may together capture a wide range of the user's reactions, while the user watches a movie or consumes other media content. Examples of collected data can range from acoustic signatures of laughter to detect which scenes were funny, to the stillness of the tablet indicating intense drama. By detecting or otherwise determining these reactions from multiple users, one or more of the exemplary embodiments can automatically generate content ratings. In one or more exemplary embodiments, the ratings need not be one number, but rather can use results that are expanded to capture the user's experience. The particular type of device that presents the media content and collects the reaction data can vary, including mobile devices (e.g., smart phones, tables, laptop computers, mobile media players, and so forth) and fixed devices (e.g., set top boxes, televisions, desktop computers, and so forth). Reference to a tablet or mobile device throughout this disclosure are examples of the devices, and the exemplary embodiments can apply the techniques described herein utilizing other devices including utilizing combinations of devices in a distributed environment.

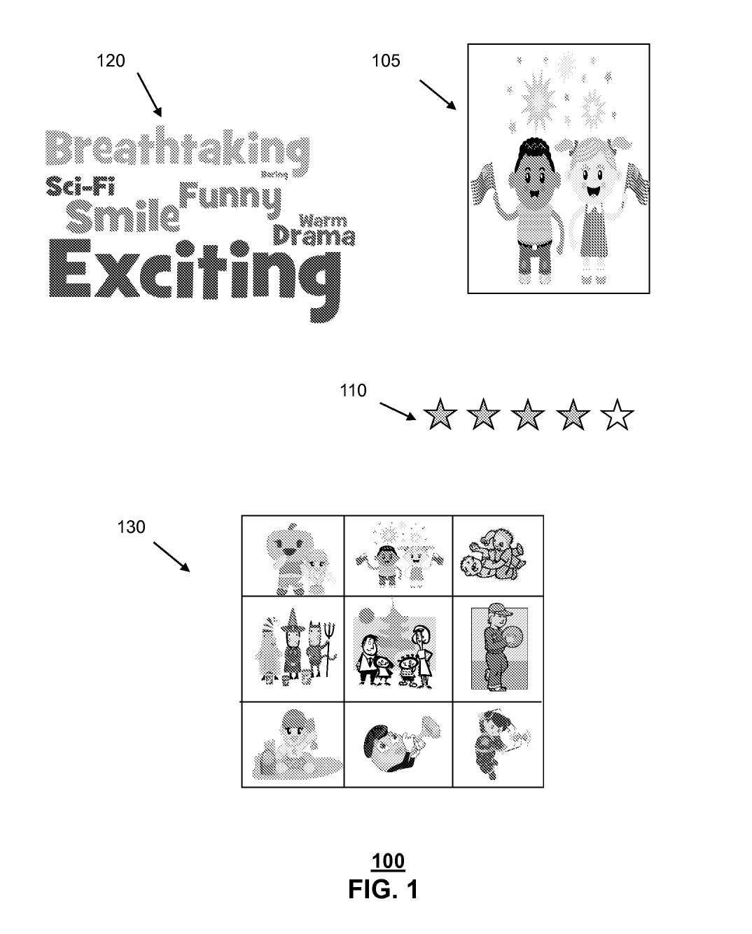

One or more of the exemplary embodiments can provide content ratings that serve as “quality indicators” to help a user make more informed decisions. For example, as shown in FIG. 1, a content rating 100 can include a movie thumbnail 105 presented with a star rating 110, as well as a tag-cloud of user reactions 120, and short clips 130 indexed by these reactions, such as, all scenes that were funny. One or more of the exemplary embodiments can expand the quality indicators beyond a simple rating number that is a highly-lossy compression of the viewer's experience. One or more of the exemplary embodiments can also obtain or otherwise collect the reaction data to generate the quality indicators or inferred user reactions while doing so with a reduced or minimal amount of user participation. In one or more embodiments, multiple content ratings from a number of different users can be analyzed to determine a total content rating. The exemplary embodiments allow for the individual content ratings and the total content ratings to be shared with other users.

One or more of the exemplary embodiments can utilize sensors of a mobile platform, such as sensors on smartphones and/or tablets. When users watch a movie on these devices, a good fraction of their reactions can leave a footprint on various sensing dimensions of these devices. For instance, if the user frequently turns her head and talks, which is detectible through the front facing camera and microphone, the exemplary embodiments can infer a user's lack of attention to that movie. Other kinds of inferences may arise from one or more of laughter detection via the microphone, the stillness of the device from the accelerometer, variations in orientation from a gyroscope, fast forwarding of the movie, and so forth. At the end of the media content, such as a movie, when users assign ratings, one or more of the exemplary embodiments can determine the mapping between the sensed reactions and these ratings. Later, the knowledge of this mapping can be applied to other users to automatically compute their ratings, even when they do not provide one. In one embodiment, the sensed information can be used to create a tag-cloud of reactions as illustrated by reactions 120, which can display a “break-up” or categorization of the different emotions evoked by the movie. In one embodiment, a user can watch a set of the short clips 130 that pertain to any of these displayed categorizations of emotions. The exemplary embodiments can provide the short clips and/or the categorized emotions since user reactions can be logged or otherwise determined for each segment, including across multiple users. One or more of the exemplary embodiments can provide a customized trailer for the media content, which is customized to specific reactions in the movie. The mapping can be performed utilizing various techniques including time stamping associated with the content presentation.

One or more of the exemplary embodiments can adjust for diversity in human reactions, such as a scene that may be funny to one user, but not to another user. Data recorded over many users can assist in drawing out the dominant effects. If a majority or other threshold of viewers laughs during a specific segment, the exemplary embodiments can assign a “funny” tag to this segment. In one embodiment, a weight proportional to the size of the majority can also be assigned to the segment. For example, the weights can also inform the attributes of the tag-cloud, such as when a large number of users laugh during presentation of a movie, the size of “funny” in the tag-cloud can be proportionally large. As another example, if a particular segment is deemed to be “exciting” by the largest amount of users as compared to the correlation of tags for other segments then the “Exciting” tag can appear larger than the other tags as illustrated in the tag-cloud of reactions 120 of FIG. 1.

One or more of the exemplary embodiments can adjust for energy consumption in gathering or collecting the data, such as adjusting data collection based on the combined energy drain from playing the movie and running the sensing/computing algorithms. As an example, when the tablet is not plugged into power, energy usage may be a valid concern. However, a large viewer base for a movie can enable compensation for the energy drain by expending energy for sensing only over portion(s) of the presented media content. One or more of the exemplary embodiments can duty-cycle the sensors at a low rate such that the sensors are activated at non-overlapping time segments for different users. If each segment has some user input from some user, it is feasible to stitch together one rating of the entire movie. The rating can become more statistically significant with more users being utilized for the collection of data. It should be understood that the exemplary embodiments can utilize data collected from portions of the movie and/or can utilize data collected from the entire movie. Additionally, a single user can be utilized for generating a content rating or multiple users can be used for generating a content rating.

As an example, one or more mobile devices that are receiving power from an external source, such as a power outlet, may provide user reaction data via the mobile device's sensors throughout the entire movie, while one or more other mobile devices that are only being powered by their battery may duty-cycle their sensors so that the sensors only collect data during designated portions of the movie. In one or more embodiments, a media server or other computing device can coordinate the duty-cycling for the mobile devices so that the entire movie is covered by the data collection process. The coordination of the duty-cycling can be performed based on various factors, including user reliability (e.g., turn-around time) in consuming content, user preferences, monitored user consumption behavior, user reactions that need confirmation, a lack of user reactions for a particular segment, and so forth.

One or more of the exemplary embodiments can enable a timeline of a movie to be annotated with reaction labels (e.g., funny, intense, warm, scary, and so forth) so that viewers can jump ahead to desired segments. One or more of the exemplary embodiments can enable the advertisement industry to identify the “mood” of users and provide an ad accordingly. For instance, a user who responds to a particular scene with a particular user reaction can be presented with a specific ad. One or more of the exemplary embodiments can enable creation of automatic highlights of a movie, such as consisting of all action scenes. One or more of the exemplary embodiments may provide a service where video formats include meta labels on a per-segment basis, where the labels can pop up before the particular segment is about to appear on display. For example, certain parts of the media content can be essentially highlighted if someone else has highlighted that part, thereby helping the viewer to focus better on the media content. Similarly, even with movies, the user might see a pop up indicating a romantic scene is imminent, or that the song is about to stop. One or more of the exemplary embodiments may offer educational value to film institutes and mass communication departments, such as enabling students to use reaction logs as case studies from real-world users.

One or more of the exemplary embodiments facilitate the translation of reaction data to ratings of media content, including video, audio, video games, still images, and so forth. As an example, a viewer's head pose, lip movement, and eye blinks can be detected and monitored over time to infer reactions. The user's voice can be separated from the sounds of the movie (which may be audible if the user is not wearing headphones) or other sounds in the environment surrounding the presentation device, and classified, such as either laughter or speech. In one or more embodiments, patterns in accelerometers and gyroscopes of the presentation device (e.g., a smart phone or tablet) can be identified and translated to user focus or distractions. In one or more embodiments, the function that translates user reactions to ratings can be estimated through machine learning, and the learnt parameters can be used to create (e.g., semantically richer) labels about the media content.

As described later herein, an example embodiment was incorporated in part into Samsung tablets running the Android operating system, which were distributed to users for evaluation. Results of the example process indicated that final ratings were generated that were consistently close to the user's inputted ratings (mean gap of 0.46 on a 5 point scale), while the generated reaction tag-cloud reliably summarized the dominant reactions. The example embodiment also utilized a highlights feature which extracted reasonably appropriate segments, while the energy footprint for the tablets remained small and tunable.

One or more of the exemplary embodiments can automatically rate content at different granularities with minimal user participation while harnessing multi-dimensional sensing available on presently available tablets and smartphones. For example, one of the embodiments can be implemented by software distributed to existing mobile devices, where the software makes use of sensors that are already provided with the mobile devices. One or more of the exemplary embodiments can sense user reactions and translate them to an overall system rating. This can include processing the raw sensor information to produce rating information at variable granularities, including a tag-cloud and a reaction-based highlight.

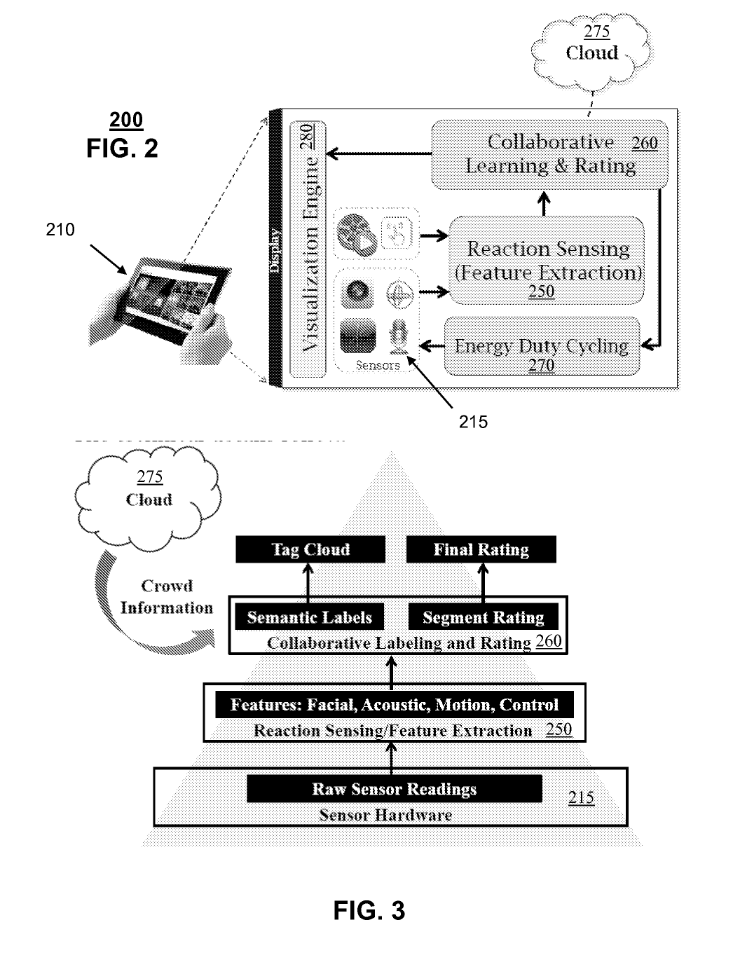

Referring to FIG. 2, a high level architecture or framework 200 for collecting the reaction data from sensors 215 and generating the content rating, is illustrated which consists of the media player or device 210 and a cloud 275. The media player 210 can include three modules, which are the Reaction Sensing and Feature Extraction (RSFE) 250, the Collaborative Learning and Rating (CLR) 260, and the Energy Duty-Cycling (EDC) 270. These modules can feed their information into a visualization engine 280, which can output the variable-fidelity ratings. The media player 210, which can be a number of different devices including fixed or mobile devices (e.g., smart phone, tablet, set top box, television, desktop computer, and so forth) can be in communication with other computing devices, such as in the cloud 275.

When a user watches a video via the media player 210, all or some of the relevant sensors 215 can be activated, including one or more of a camera (e.g., front-facing camera), microphone, accelerometer, gyroscope, and available location sensors. While this example utilizes sensors 215 that are integrated with the media player 210, the exemplary embodiments can also utilize sensors that are external to the media player, such as sensors on a mobile device in proximity to the user which can forward the collected data to the media player 210. The raw sensor readings can be provided from the sensors 215 to the RSFE module 250, which is tasked to distill out the features from raw sensor readings.

In one embodiment, the inputs from the front-facing camera of media player 210 can be processed to first detect a face, and then track its movement over time. Since the user's head position can change relative to the tablet camera, the face can be tracked even when it is partly visible. The user's eyes and/or lips can also be detected and tracked over time. As an example, frequent blinks or shutting-down of the eyes may indicate sleepiness or boredom, while stretching of the lips may suggest funny or happy scenes. A visual sub-module of the RSFE module 250 can execute these operations to extract sophisticated features related to the face, eyes, and/or lips, and then can feed the features to the CLR module 260. Complications can occur when the user is watching the movie in the dark, or when the user is wearing spectacles, making eye detection more difficult. The RSFE module 250 can account for these complications in a number of different ways, including applying filtering techniques to the data based on cross-referencing collected data to confirm data validity.

In one embodiment, an acoustic sub-module of the RSFE module 250 can be tasked to identify when the user is laughing and/or talking, which can reveal useful information about the corresponding segments in the movie or other media content. A challenge can arise if a user utilizes an in-built speaker of the media player 210 while watching a movie, which in turn gets recorded by the microphone. The RSFE module 250 can be utilized such that the user's voice (e.g., talking and/or laughter) can be reliably discriminated against the voices and sounds from the movie and/or sounds from the environment surrounding the media player 210. One or more of the exemplary embodiments can use speech enhancement techniques, as well as machine learning, to accomplish this goal. In one or more embodiments, user voice samples can be utilized as a comparator for discerning between media content audio and recorded audio of the user, as well as filtering out environmental noises (e.g., a passerby's voice). In another example, the user's environment can be determined for further filtering out audio noise to determine the user's speech and/or laughter. As an example, the media player 210 can utilize location information to determine that the player 210 is outside in a busy street with loud noises in the environment. This environmental noise can be utilized as part of the audio analysis to determine the user's audio reactions to the media content.

In one embodiment, motion sensors can be utilized for inferring or otherwise determining the user's reactions to the media content. For example, the RSFE module 250 can detect stillness of the tablet 210 (e.g., during an intense scene), or frequent jitters and random fluctuations (e.g., when the user's attention is less focused). For example, the stillness can be a lack of motion of the player 210 or an amount of motion of the device that is under a particular threshold. In some of the cases, the user may shift postures and the motion sensors can display a burst of high variance. These events may be correlated to the logical end of a scene in the movie, and can be used to demarcate which segments of the movie can be included in the highlights. For instance, stillness of the tablet 210 from time t5, followed by a bursty motion marker at t9, can indicate that the interval [t5; t9] was intense, and may be included in the movie's highlights. Motion sensors can also be utilized as a useful tool for collecting reaction data to compensate for when the user's face moves out of the camera view, or when the user is watching in the dark.

In addition to sensory inputs, one or more of the exemplary embodiments can exploit how the user alters, through trick play functions (e.g., fast-forward, rewind, pause), the natural play-out of the movie. For instance, moving back the slider to a recent time point can indicate reviewing the scene once again; forwarding the slider multiple times can be a degree of impatience. Also, the point to which the slider is moved can be utilized to mark an interesting instant in the video. In one or more embodiments, if the user multiplexes with other tasks during certain segments of the movie (e.g., email, web browsing, instant messaging), those segments of the media content may be determined to be less engaging. The RSFE module 250 can collect some or all of these features into an organized data structure, normalizes them between [−1, 1], and forwards them to the CLR module 260.

In one embodiment, content storage and streaming, such as with movies and videos, can take advantage of a cloud-based model. The ability to assimilate content from many cloud users can offer insights into behavior patterns of a collective user base. One or more of the exemplary embodiments can benefit from access to the cloud 275. In particular, one or more of the exemplary embodiments can employ collaborative filtering methods. If some users provide explicit ratings and/or reviews for a movie or other media content or a portion thereof, then all or some of the sensor readings (i.e., collected reaction data) for this user from the particular end user device can be automatically labeled with the corresponding rating and semantic labels. This knowledge can be applied to label other users' movies, and link their sensor readings to ratings. With more labeled data from users, one or more of the exemplary embodiments can improve in its ability to learn and predict user ratings.

One or more of the exemplary embodiments can implement policy rules to address privacy concerns regarding sensing user reactions and exporting to such data to a cloud, such as with data gathered from face detection. In one embodiment, none of the raw sensor readings are revealed or otherwise transmitted from the device 210 that collects the reaction data. For example, in one embodiment, upon approval from the user, only the features, ratings, and semantic labels (or any subset of them with which the user is comfortable) may be exported. In the degenerate case, one or more of the exemplary embodiments may only upload the final star rating and discard the rest, except that the rating will be determined automatically. Collaborative filtering algorithms that apply to star ratings, may similarly apply to one or more of the exemplary embodiments' ratings.

In one or more embodiment, when the tablet 210 is connected to a power-outlet or other external power source, the EDC module 270 and/or duty-cycle instructions may be ignored or otherwise rendered inoperative. However, when running on a battery or when other factors make it desirable to reduce energy consumption of the device 210, the EDC module 270 can minimize or reduce energy consumption resulting from collecting and/or analyzing data from the sensors (e.g., images, audio recordings, movement information, trick play monitoring, parallel processing monitoring, and so forth). Some power gains can be obtained individually for sensors. For instance, the microphone can be turned off until the camera detects some lip activity—at that point, the microphone can discriminate between laughter and speech. Also, when the user is holding the tablet still for long durations, the sampling rate of the motion sensors can be ramped down or otherwise reduced.

Greater gains can also be implemented by one or more of the exemplary embodiments by exploiting the collective user base and obtaining or otherwise collecting reaction data for only a portion of the media content (e.g., a movie) for those communication devices in which energy consumption is to be reserved. In one embodiment, duty-cycle instructions can be utilized for activating and deactivating the sensors to conserve power of the device 210. These duty-cycle instructions can be generated by the device 210 and/or received from another source, such as a server that is coordinating the collection of ratings (e.g., segment ratings or total ratings) or other information (e.g., semantic labels per segment) from multiple users.

One or more of the exemplary embodiments can collect from the sensors the reaction data for users during different time segments of the media content, such as during non-overlapping time segments, and then “stitch” the user reactions to form the overall rating. While user reactions may vary across different users, the use of stitching over a threshold number of users can statistically amplify the dominant effects. In one or more exemplary embodiments, the stitching can be performed utilizing information associated with the users. For instance, if it is known (e.g., through media consumption monitoring, user profiles, user inputted preferences, and so forth) that Alice and Bob have similar tastes in horror movies, the stitching of reactions can be performed only across these users.

In one embodiment, potential users can be analyzed based on monitored consumption behavior of those potential users and a subset of the users can be selected based on the analysis to facilitate the stitching of user reactions for a particular movie or other media content. As an example, a subset of users whose monitored consumption behavior indicates that they often watch action movies in a particular genre may be selected for collecting data for a particular action movie in the same or a similar genre. In another embodiment, other factors can be utilized in selecting users for collecting reaction data. For example, a correlation between previous user reaction data for a subset of users, such as users that similarly laughed out loud in particular points of a movie may be used as a factor for selecting those users to watch a comedy and provide reaction data for the comedy. In one embodiment, a server can distribute duty-cycle instructions to various communication devices that indicate portions of the media content for which reaction data is to be collected. As an example, the duty-cycle instructions can be generated based on the monitored consumption behavior. As another example, the duty-cycle instructions can indicate overlapping and/or non-overlapping portions of the media content for data collection such that data is collected from the group of devices for the entire length of the media content. In another embodiment, one or more of the devices can be assigned reaction data collection for multiple portions of media content, including based on feedback, such as a determination of a lack of data for a particular portion of the media content or as a tool to confirm or otherwise validate data received for a particular portion of the media content from other devices.

Referring to FIG. 3, the RSFE module 250 can process the raw sensor readings from the sensors 215 and can extract features to feed to CLR module 260. The CLR module 260 can then translate the processed data to segment-wise labels to create a collection of “semantic labels”, as well as segment-wise ratings referred to as “segment ratings.” Techniques such as collaborative filtering, Gaussian process regression, and support vector machines can be employed to address different types of challenges with processing the data. The segment ratings can be merged to yield the final “star rating” shown in FIG. 1 while the semantic labels can be combined (e.g., in proportion to their occurrence frequencies) to create a tag-cloud. In one or more embodiments, segments tagged with similar semantic labels can be “stitched” to create reaction-indexed highlights 120 as shown in FIG. 1. Thus, from the raw sensor values to the final star rating, one or more of the exemplary embodiments can distill information at various granularities to generate the final summary of the user's experience.

One or more of the exemplary embodiments can utilize face detection, eye tracking, and/or lip tracking in the collection and analysis of reaction data. The front facing camera on a mobile device often does not capture the user's face from an ideal angle. In one or more of the exemplary embodiments, a top-mounted camera may capture a tilted view of a user's face and eyes, which can be compensated for as a rotational bias. Due to relative motion between the user and the mobile device, the user's face may frequently move out of the camera view, either fully or partially. One or more of the exemplary embodiments can account for difficulties in performing continuous face detection or users wearing spectacles adds to the complexity. One or more of the exemplary embodiments can utilize a field of view of the mobile device that is limited, making it easier to filter out unknown objects in the background, and extract the dominant user's face. Also, for any given user, particular head-poses may be likely to repeat more than others due to the user's head-motion patterns. These detected patterns can be utilized as part of the recognition process. One or more of the exemplary embodiments can utilize a combination of face detection, eye tracking, and lip tracking, based on contour matching, speeded up robust feature (SURF) detection, and/or frame-difference based blink detection algorithms.

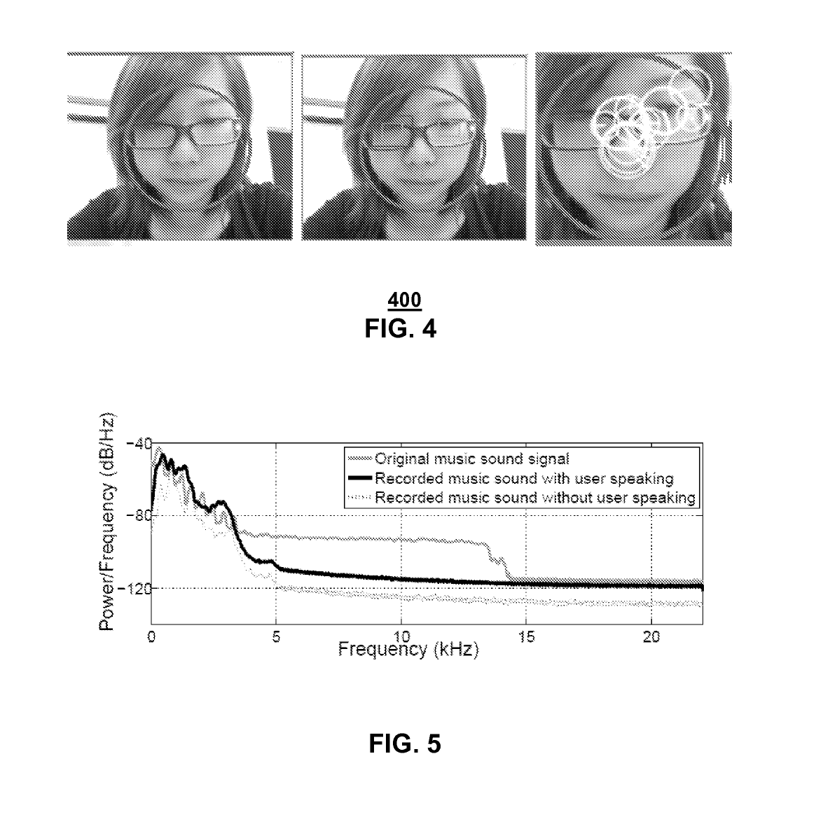

As an example of a data collection process which can be performed during one or more portions of a presentation of media content or can be performed over the entire presentation of the media content, one or more of the exemplary embodiments can run (e.g., continuously or intermittently) a contour matching algorithm on each frame for face detection. If a face is detected, the system can run contour matching for eye detection and can identify the SURF image keypoints in the region of the face. These image keypoints may be viewed as small regions of the face that maintain very similar image properties across different frames, and hence, may be used to track an object in succeeding frames. If a full face is not detected, one or more of the exemplary embodiments can track keypoints similar to previously detected SURF keypoints, which allows detecting and tracking a partial face, and which occurs frequently in real life. When no satisfying matching point is found, or the lack of a face exceeds one minute, one or more of the exemplary embodiments can stop the tracking process because the tracked points may not be reliable any more. Pipelined with the face detection process, one or more of the exemplary embodiments can run an algorithm to perform blink-detection and eye-tracking. For instance, the difference in two consecutive video frames can be analyzed to extract a blink pattern. Pixels that change across frames can essentially form two ellipses on the face that are close and symmetric, suggesting a blink. For eye-tracking, contour matching-based techniques may fail when users are wearing spectacles, but can be compensated for by applying the blink analysis. This is because spectacles usually remain the same between two consecutive video frames, and hence, the blink/eye position can be recognized. FIG. 4 illustrates an intermediate output 400 in this exemplary algorithm. Here, the exemplary algorithm detects the face through the tablet camera view, detects the eyes using blink detection, and finally tracks the keypoints.

One or more of the exemplary embodiments may draw out one or more of the following features: face position, eye position, lip position, face size, eye size, lip size, relative eye and lip position to the entire face, and/or the variation of each over the duration of the movie. These features can capture some of the user reaction footprints, such as attentiveness, delight, distractedness, etc.

In one or more of the exemplary embodiments, the media player 210 can activate a microphone and record ambient sounds while the user is watching the movie, where this sound file is the input to the acoustic sensing sub-module. The key challenge is to separate the user's voice from the movie soundtrack, and then classify the user's voice, such as laughter or speech. Since the movie soundtrack played on the speakers can be loud, separation may not be straight forward. Given that the human voice exhibits a well-defined footprint on the frequency band (bounded by 4 KHz), one or more of the exemplary embodiments can pull out this band (e.g., using a low pass filter) and then perform separation. However, some devices (e.g., a tablet or smart phone) may already perform this filtering (to improve speech quality for human phone calls, video chats, or speech to text software). Thus, even though frequency components greater than 4 KHz are suppressed in the recorded sound file, the residue may still be a strong mix of the human voice and the movie soundtrack. FIG. 5 demonstrates this by comparing a Welch Power Spectral Densities of the following: (1) the original movie soundtrack, (2) the sound of the movie recorded through the tablet microphone, and (3) the sound of the movie and human voice, recorded by the tablet microphone.

In this example, the recorded sounds drop sharply at around 4 KHz. At less than 4 KHz, the movie soundtrack with and without human voice are comparable, and therefore non-trivial to separate. One or more of the exemplary embodiments can adopt two heuristic techniques to address the problem, namely (1) per-frame spectral density comparison, and (2) energy detection before and after speech enhancement. These techniques can be applicable in different volume regimes.

In per-frame spectral density comparison, the power spectral density within [0, 4] KHz is impacted by whether the user is speaking, laughing, or silent. In fact, the energy from the user's voice gets added to the recorded soundtrack in certain frequencies. FIG. 5 demonstrates an example case where the user's voice elevates the power at almost all frequencies. However, this is not always necessary, and is a function of the volume at which the soundtrack is being played, and the microphone hardware's frequency response. The recorded signals and the original soundtrack can be divided into 100 ms length frames. For each frame, the (per-frequency) amplitude of the recorded sound can be compared with the amplitude from the original soundtrack. If the amplitude of the recorded signal exceeds the soundtrack in more than 7% of the frequency bands, it is determined that this video frame contains the user's voice. To avoid false positives, it is required that F consecutive frames exist to satisfy this condition. If satisfied, it is inferred that the human spoke or laughed during these frames. The start and end times of user's vocalization can be extracted by combining all the frames that were detected to contain human voice.

In energy detection with speech enhancement, speech enhancement tools can suppress noise and amplify the speech content in an acoustic signal. One or more of the exemplary embodiments use this by measuring the signal (root mean square) energy before and after speech enhancement. For each frame, if the RMS energy diminishes considerably after speech enhancement, this frame is determined to contain voice. Signals that contain speech will undergo background noise suppression; those that do not will not be affected.

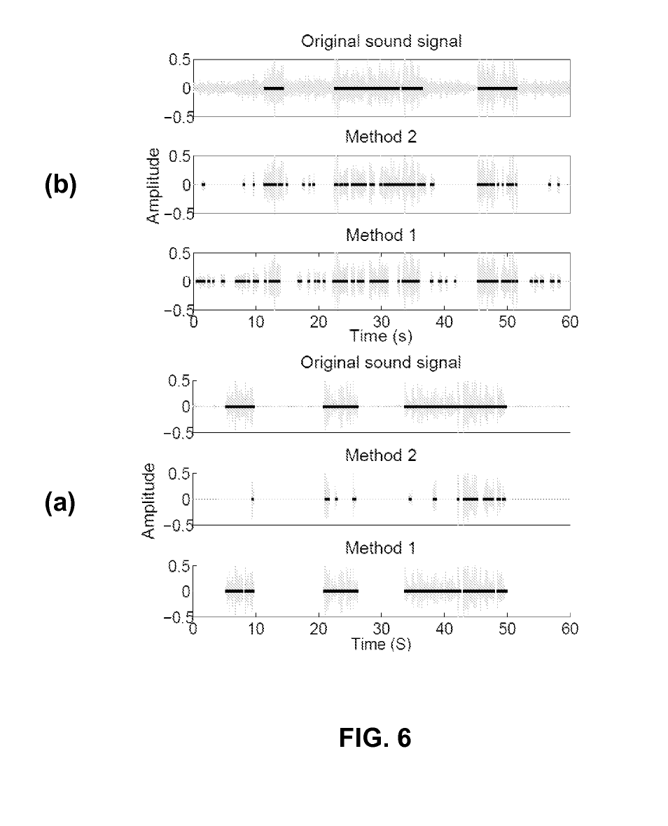

The two heuristic processes described above perform differently under different volumes of the tablet speakers as shown in the results of FIG. 6. FIG. 6(a) reports their performance when the tablet volume is high—the dark horizontal lines represent the time windows when the user was actually speaking. The first heuristic—per-frame spectral density comparison—exhibits better discriminative capabilities. This is because at high volumes, the human speech gets drowned by the movie soundtrack, and speech enhancement tools become unreliable. However, for certain frequencies, the soundtrack power is still low while the human voice is high, thereby allowing power-spectral-density to detect the voice. FIG. 6(b) shows how the converse is true for low tablet volume. Speech enhancement tools are able to better discriminate human voice, leading to higher detection accuracy. The volume regimes can be chosen through empirical experiments—when the movie volume is higher than 75% of the maximum volume, one can use the first heuristic, and vice versa.

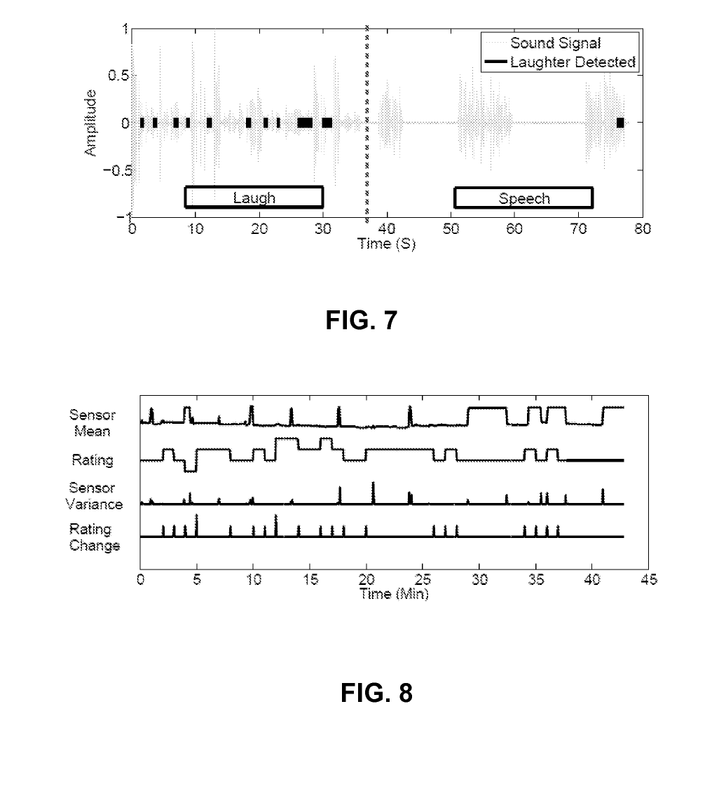

One or more of the exemplary embodiments can assume that acoustic reactions during a movie are either speech or laughter. Thus, once human voice is detected, a determination of whether the voice corresponds to speech or laughter can be made. In one embodiment, a support vector machine (SVM) classifier can be utilized and can be trained on the Mel-frequency cepstral coefficients (MFCC) as the principle features. In sound processing, Mel-frequency cepstrum is a representation of the short-term power spectrum of a sound. MFCC can be used as features in speech recognition and music information retrieval. The SVM classification achieved a laughter-detection accuracy of 90%, however, the false positive rates were somewhat high—18%. To reduce false positives, one or more of the exemplary embodiments can perform an outlier detection. If a frame is labeled as laughter, but all 4 frames before and after are not, then these outlier frames can be eliminated. FIG. 7 shows the results—the false positive rate now diminishes to 9%.

Accelerometer and gyroscope readings can also contain information about the user's reactions. The mean of the sensor readings is likely to capture the typical holding position/orientation of the device, while variations from it are indicators of potential events. One or more of the exemplary embodiments can rely on this observation to learn how the (variations in) sensor readings correlate to user excitement and attention. FIG. 8 shows the stillness in accelerometer and gyroscope, and how that directly correlates to the segment ratings change labeled by a specific user (while watching one of her favorite movies).

In one or more embodiments, the use of the touch screen can be utilized for reaction data. Users tend to skip boring segments of a movie and, sometimes, may roll back to watch an interesting segment again. The information about how the user moved the slider or performed other trick play functions can reveal the user's reactions for different movie segments. In one or more of the exemplary embodiments, the video player can export this information, and the slider behavior can be recorded across different users. If one or more of the exemplary embodiments observes developing trends for skipping certain segments, or a trend in rolling back, the corresponding segments can be assigned proportionally (lower/higher) ratings. For example, when a user over-skips and then rolls back slightly to the precise point of interest, one or more of the exemplary embodiments can consider this as valuable information. The portion on which the user rolled back slightly may be to the user's interest (therefore candidate for high rating), and also is a marker of the start/end of a movie scene (useful for creating the highlights). Similar features that can be monitored for generating user reaction also include volume control and/or pause button. Over many users watching the same movie, the aggregated touch screen information can become more valuable in determining user reactions to different segments of the media content. For example, a threshold number of users that rewind a particular segment may indicate the interest of the scene to those viewers.

One or more of the exemplary embodiments can employ machine learning components to model the sensed data and use the models for at least one or more of the following: (1) predict segment ratings; (2) predict semantic labels; (3) generate the final star rating from the segment ratings; (4) generate the tag-cloud from the semantic labels. Segment ratings can be ratings for every short segment of the movie, to assess the overall movie quality and select enjoyable segments.

One or more of the exemplary embodiments can compensate for the ambiguity in the relationship between reaction features and the segment rating. User habits, environment factors, movie genre, and so forth can have direct impact on the relationship. One or more of the exemplary embodiments can employ a method of collaborative filtering and Gaussian process regression to cope with such difficulties. For example, rounding the mean of the segment ratings can yield the final star rating. The exemplary embodiments can provide semantic labels that are text-based labels assigned to each segment of the movie. CLR 260 can generate two types of such labels—reaction labels and perception labels. Reaction labels can be a direct outcome of reaction sensing, reflecting on the viewer's behavior while watching the movie (e.g., laugh, smile, focused, distracted, nervous, and so forth). Perception labels can reflect on subtle emotions evoked by the corresponding scenes (e.g., funny, exciting, warm, etc.). One or more of the exemplary embodiments can request multiple users to watch a movie, label different segments of the movie, and provide a final star rating. Using this as the input, one or more of the exemplary embodiments can employ a semi-supervised learning method combining collaborative filtering and SVM to achieve good performance. Aggregating over all segments, one or more of the exemplary embodiments can count the relative occurrences of each label, and develop a tag-cloud of labels that describes the movie. The efficacy of classification can be quantified through cross-validation.

### Example

An example process was employed in which volunteers were provided with Android tablets and asked to watch movies using sensor-assisted media player, which records sensor readings during playback and stores them locally on the tablet. Volunteers were asked to pick movies that they have not watched in the past from a preloaded small movie library to gauge their first impression about the movies. Since volunteers could watch movies at any place and time they chose, their watching-behaviors were entirely uncontrolled (in fact, many of them took the tablets home). At some point after watching a movie, participants were asked to rate the movie at a fine-grained resolution. A tool was developed that scans through the movie minute by minute (like fast-forwarding) and allows volunteers to rate segments on a scale from 1 to 5. Instead of rating each 1-minute segment individually, volunteers were able to assign the same rating to multiple consecutive segments simultaneously by providing ratings for just the first and the last segments in each series. Volunteers also labeled some segments with “perception” labels, indicating how they perceived the attributes of that segment. The perception labels were picked from a pre-populated set. Some examples of such labels are “funny”, “scary”, “intense”, etc. Finally, volunteers were asked to provide a final (star) rating for the movie as a whole, on a scale of 1 to 5. In total, 10 volunteers watched 6 movies across different genres, including comedy, horror, crime, etc. However, one of the volunteer's data was incomplete and was dropped from the analysis. The final data set contained 41 recorded videos from 9 volunteers. Each video was accompanied by sensor readings, segment ratings, perception labels and final ratings.

The example process models user behavior from the collected labeled data, and used this model to predict (1) segment ratings, (2) perception labels, and (3) the final (star) rating for each movie. The example process predicts human judgment, minute by minute.

The example process compensated for three levels of heterogeneity in human behavior: (1) Users exhibit behavioral differences; (2) Environment matters; and (3) Varying user tastes.

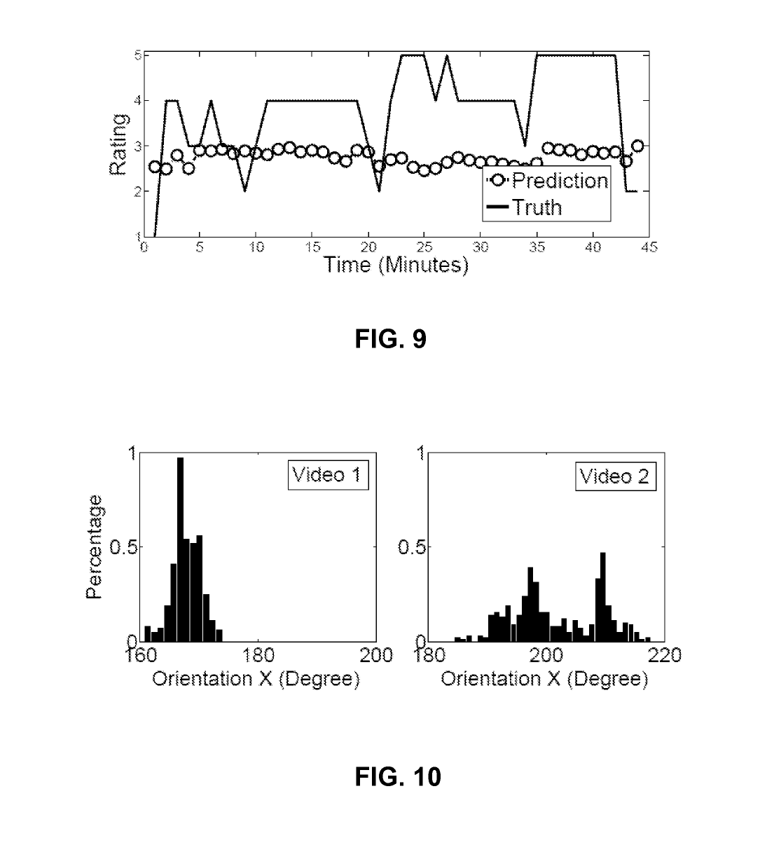

(1) Users exhibit behavioral differences: Some users watch movies attentively, while others are more casual, generating more movement and activity. Such diversities are common among users, and particularly so when observed through the sensing dimensions. As a result, a naive universal model trained from a crowd of users is likely to fail in capturing useful behavioral signatures for any specific user. In fact, such a model may actually contain little information since the ambiguity from diverse user behaviors may mask (or cancel out) all useful patterns. For example, if half of the users hold their devices still when they are watching a movie intensely, while the other half happen to hold their devices still when they feel bored, a generic model learned from all this information will not be able to use this stillness feature to discriminate between intensity and boredom. Thus, a good one-fit-all model may not exist such as a regression model for estimating segment ratings using all available labeled data. FIG. 9 plots the cross-validation results for the leave-one-video-out method, comparing this model's estimated segment ratings vs. the actual user ratings. The results show that the model's estimates fail to track the actual user ratings, while mostly providing the mean rating for all segments.

(2) Environment matters: Even for the same user, her “sensed behavior” may differ from time to time due to different environmental factors. For instance, the behavior associated with watching a movie in the office may be substantially different from the behavior during a commute, which is again different from the one at home. FIG. 10 shows the orientation sensor data distribution from the same user watching two movies. The distribution clearly varies even for the same user.

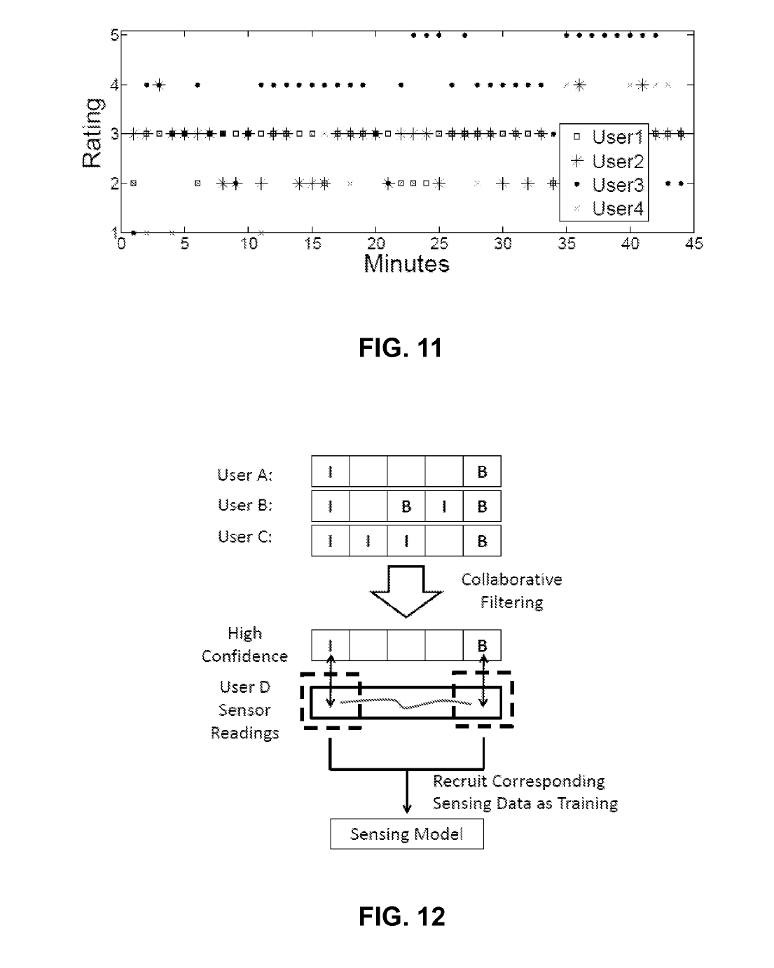

(3) Varying user tastes: Finally, users may have different tastes, resulting in different ratings/labels given to the same scene. Some scenes may appear hilarious to one, and may not be so to another. FIG. 11 shows the ratings given to the same movie by four different users. While some similarities exist, any pair of ratings can be quite divergent.

To compensate for these three levels of heterogeneity in human behavior, the example process developed a model that captures the unique taste of a user and her behavior in a specific environment. One brute force approach would be to train a series of per-user models, each tailored to a specific viewing environment and for a specific genre of a movie. However, enumerating all such environments may be resource prohibitive. And, each user would need to provide fine-grained segment ratings and perception labels for movies they have watched in each enumerated environment resulting in a large amount of user interaction. To avoid these issues, the example process generated a customized model applicable to a specific user, without requiring her to provide many fine-grained segment ratings.

The example process is based in part on users exhibiting heterogeneity overall, but their reaction to certain parts of the movie being similar. Therefore, the example process analyzes the collective behavior of multiple users to extract only the strong signals, such as learning only from segments for which most users exhibit agreement in their reactions. Similarly, for perception labels, the example process also learns from segments on which most users agree. Collaborative filtering techniques can be used to provide the ability to draw out these segments of somewhat “universal” agreement. Two separate semi-supervised learning methods can be utilized—one for segment ratings and another for perception labels. For segment ratings, collaborative filtering can be combined with Gaussian process regression. For perceived labels, collaborative filtering can be combined with support vector machines.

Continuing with the example process, when a new user watches a movie, the tablet or other device uses the sensed data from only the “universal” or target segments to train a customized model, which is then used to predict the ratings and labels of the remaining or rest of the user's segments, which may or may not be the remaining portion of the entire movie. In other words, the example process bootstraps using ratings that are agreeable in general, and by learning how the new user's sensing data correlates with these agreeable ratings, the example process learns the user's “idiosyncrasies.” Now, with knowledge of these idiosyncrasies, the example process can expand to other segments of the movie that other users did not agree upon, and predict the ratings for this specific user.

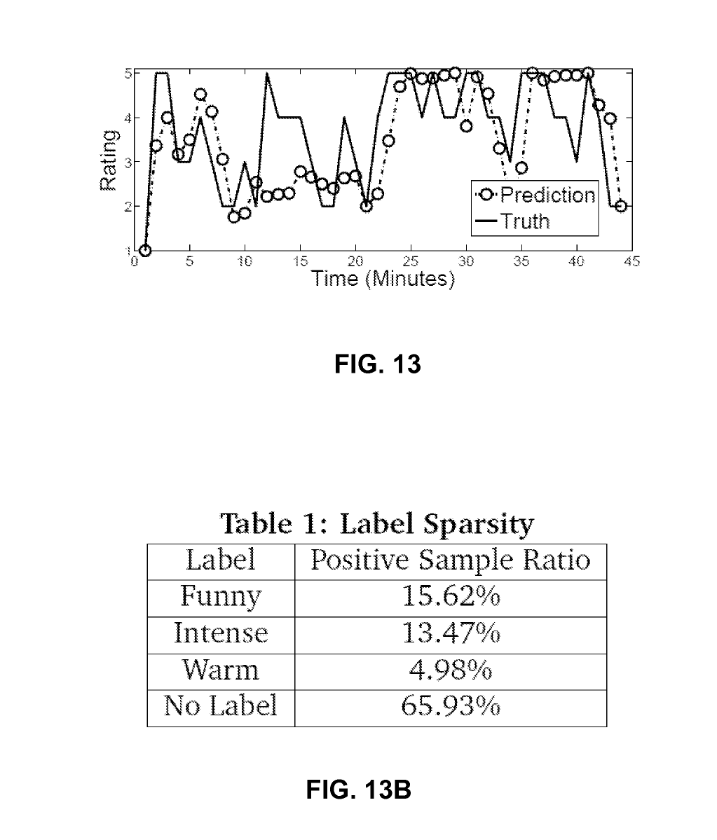

FIG. 12 illustrates the example process. From the ratings of users A, B, and C, the example process learns that minute 1 is intense (I) and minute 5 is boring (B). Then, when user D watches the movie, his sensor readings during the first and the fifth minutes are used as the training data to create a personalized model. FIG. 13 shows the accuracy of the results of the example process with estimated ratings closely following the actual user ratings.

Besides coping with inherent heterogeneity of users, the example process can compensate for (1) resolution of ratings and (2) sparsity of labels. The first problem can arise from the mismatch between the granularity of sensor readings (which can have patterns lasting for a few seconds) and the human ratings (that are in the granularity of minutes). As a result, the human labels obtained may not necessarily label the specific sensor pattern, but rather can be an aggregation of useful and useless patterns over the entire minute. This naturally raises the difficulty for learning the appropriate signatures. The situation is similar for labels as well. It may be unclear exactly which part within the 1-minute portion was labeled as hilarious since the entire minute may include both “hilarious” and “nonhilarious” sensor signals. The example process assumes that each 3 second window in the sensing data has the label of the corresponding minute. In this prediction, once the example process yields a rating/label for each 3-second entry, they can be aggregated back to the minute granularity, allowing a computation of both prediction accuracy and false positives.

In the example process, the labels gathered in each movie can be sparse; volunteers did not label each segment, but opted to label only scenes seemed worthy of labeling. This warrants careful adjustment of the SVM parameters, because otherwise SVM may classify all segments as “none of the valid labels”, and appear to achieve high accuracy (since much of the data indeed has no valid label).

Table 1 of FIG. 13B shows the ratio between labeled samples and unlabeled samples; and precisely recognizing and classifying the few minutes of the labeled segments, from 1400 minutes of recordings can be a difficult task.

The example process demonstrates the feasibility of (1) predicting the viewer's enjoyment of the movie, both on segment level and as a whole and (2) automatic labeling movie segments that describe the viewer's reaction through multi-dimensional sensing.

The example process was evaluated utilizing three measures (commonly used in Information Retrieval), which evaluate performance on rating segments and generating labels: precision, recall and fallout. Precision identifies the percentage of captured labels/enjoyable segments are correct. Recall describes the percentage of total true samples that are covered. Fall-out measures false positives ratio relative to total number of negative samples. For ground truth, the user-generated ratings and labels were used. The following is the formal definition of these evaluation metrics.

$$\begin{matrix}Precision = \frac{\vert \{ Human Selected ⋂ Pulse Selected \} \vert}{\vert \{ Pulse Selected \} \vert} & ( 1 ) \\ Recall = \frac{\vert \{ Human Selected ⋂ Pulse Selected \} \vert}{\vert \{ Human Selected \} \vert} & ( 2 ) \\ Fall \text{-} out = \frac{\vert \{ Non \text{-} Relevant ⋂ Pulse Selected \} \vert}{\vert \{ Non \text{-} Relevant \} \vert} & ( 3 )\end{matrix}$$

From the analysis of user-generated data, a summary of the example process performance is as follows:

1. Rating quality: The example process predicted segment ratings closely follow users' segment ratings with an average error of 0.7 in 5 points scale. This error is reduced to 0.3 if we collapse bad scores together, while maintaining the fidelity of good ratings. This reflects a 40% improvement over estimation based on only distribution or collaborative filtering. The example process is able to capture enjoyable segments with an average precision of 71%, an average recall of 63% with a minor fallout of 9%. The example process's overall rating for each movie is also fairly accurate, with an average error of 0.46 compared to user given ratings.

2. Label quality: On average, the example process covers 45% of the perception labels with a minor average fallout of 4%. This method shows an order of magnitude improvement over a pure SVM-based approach while also achieving better recall than pure collaborative filtering. The reaction labels also capture the audience's reactions well. Qualitative feedback from users was also very positive for the tag cloud generated by the example process.

The example process generates two kinds of ratings—segment ratings and final ratings. Segment ratings can represent a prediction of how much a user would enjoy a particular one minute movie segment while final ratings can predict how much a user would enjoy the overall movie. Ratings can be scaled from 1 (didn't like) to 5 (liked). One or more of the exemplary embodiments predicts segment ratings, then use these to generate final ratings. Additionally, highly rated (enjoyable) segments can be stitched together to form a highlight reel.

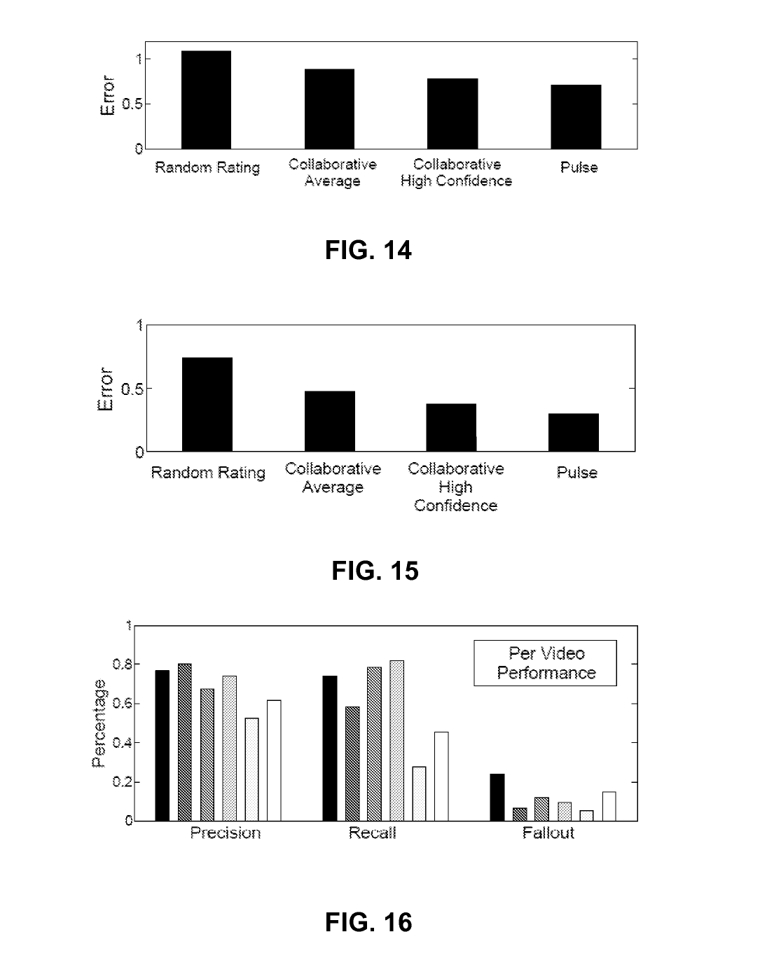

FIG. 14 shows the comparison of average rating error (out of 5 points) in predicted segment ratings. The example process captures the general trend of segment ratings much better than the other three methods: rating—assigning segment rating based on global distribution of segment ratings, collaborative filtering using universal segments only, and collaborative filtering using average segment rating of others. The example process deemed that there is little value in differentiating between very boring and slightly boring. Hence, the example process collapses all negative/mediocre ratings (1 to 3), treating them as equivalent. For this analysis, high ratings are not collapsed, since there is value in keeping the fidelity of highly enjoyable ratings. The adjusted average rating error comparison is shown in FIG. 15. Notice that because good segments are much fewer than other segments, small difference in error here can mean large a difference in terms of performance.

The example process can use the “enjoyable” segments, 4 points and up, to generate highlights of a movie. FIG. 16 shows the average performance for each movie. Precision ranges from 57% to 80% with an average recall of 63 and a minor fallout, usually less than 10%. The example process performed well on two comedies and two crime movies, corresponding to the first four bars in each group. The remaining two controversial movies were a comedy and a horror movie.

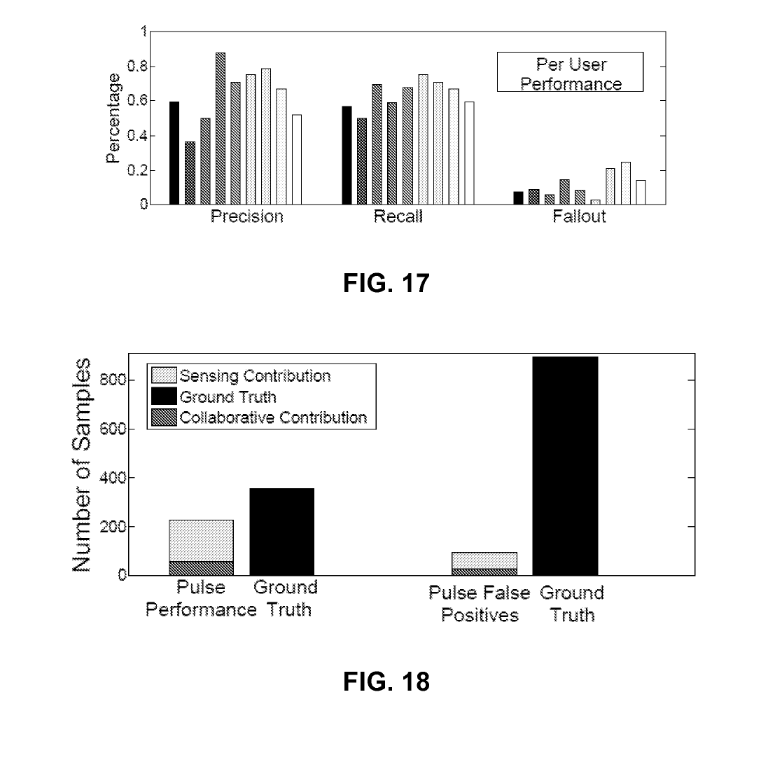

FIG. 17 shows the average performance for each user. Except for one outlier user (the second), the precision is above 50% with all recalls above 50%. Fallout ranges from 0 to 19%. Given the sparse labels, the accuracy is reasonable—on average the example process creates less than one false positive every time it includes five true positives. One can see the second user might be characterized as “picky” —the low precision, reasonable recall and small fallout suggest she rarely gives high scores. Note that all the above selections are personalized; a good segment for one user may be boring to another one and the example process can identify these interpersonal differences.

FIG. 18 illustrates the individual contribution made by collaborative filtering and by sensing. The four bars show the number of true positives, total number of positive samples, false positives, and total number of negative samples respectively. As the figure illustrates, the example process improves upon collaborative filtering by using sensing.

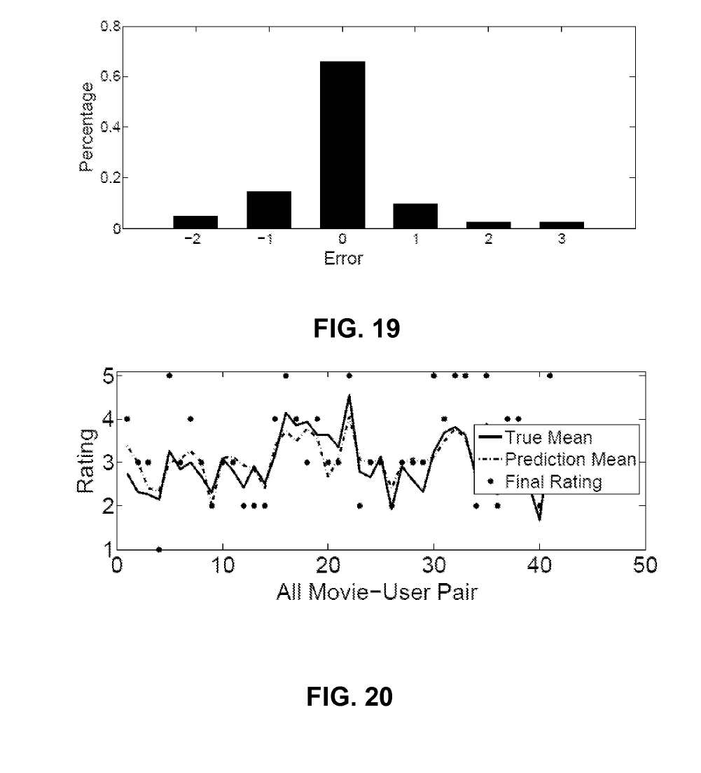

FIG. 19 shows the error distribution of the example process's final ratings when compared to users' final ratings. The example process can generate the final rating by rounding the mean of per minute segment ratings. FIG. 20 shows the mean predicted segment ratings along with the mean of true segment ratings with the corresponding user given final ratings. There is a bit of variation between how users rate individual segments versus how they rate the entire movie.

The example process associates semantic labels to each movie segment and eventually generates a tag cloud for the entire movie. The semantic labels can include reaction labels and perception labels. The example process used the videos captured by the front facing cameras to manually label viewer reactions after the study. Two reviewers manually labeled the videos collected during the example process. These manually generated labels were sued as ground truth.

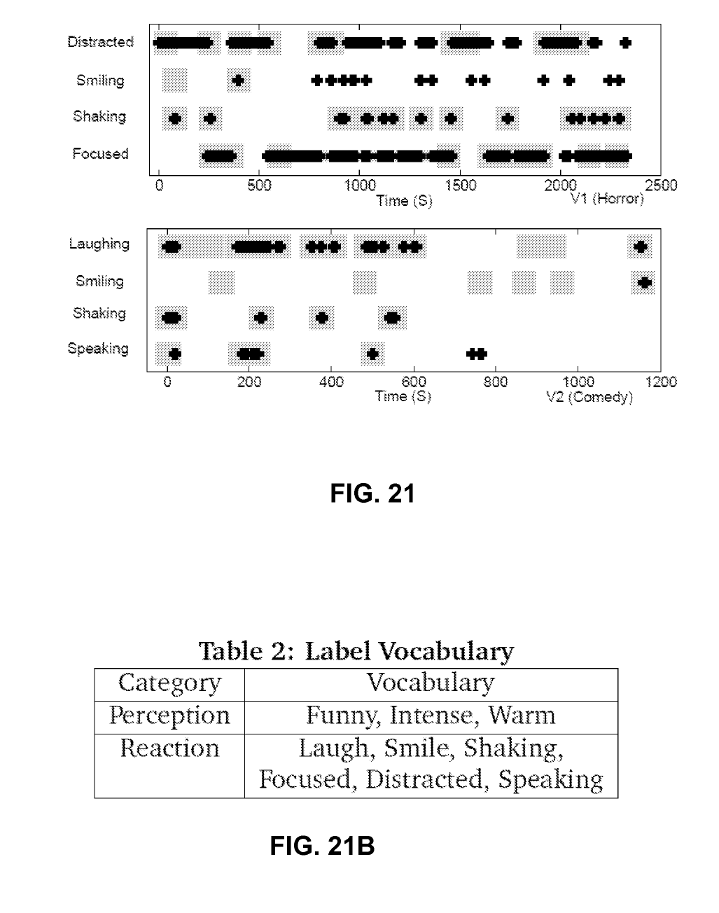

Reaction labels can represent users' direct actions during watching a movie (e.g., laugh, smile, etc.). The entire vocabulary is shown in Table 2 of FIG. 21B. FIG. 21 shows the comparison between the example process's prediction and the ground truth. The gray portion is the ground truth while the black dots are when the example process detects the corresponding labels. Though the example process, on occasion, mislabeled on a per second granularity, the general time frame and weight of each label is correctly captured.

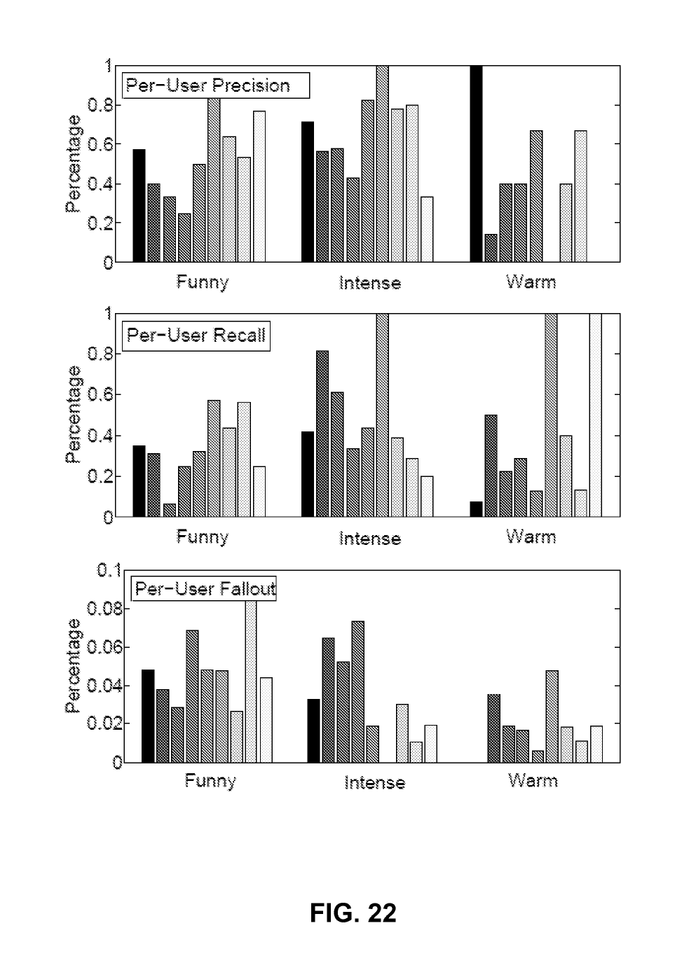

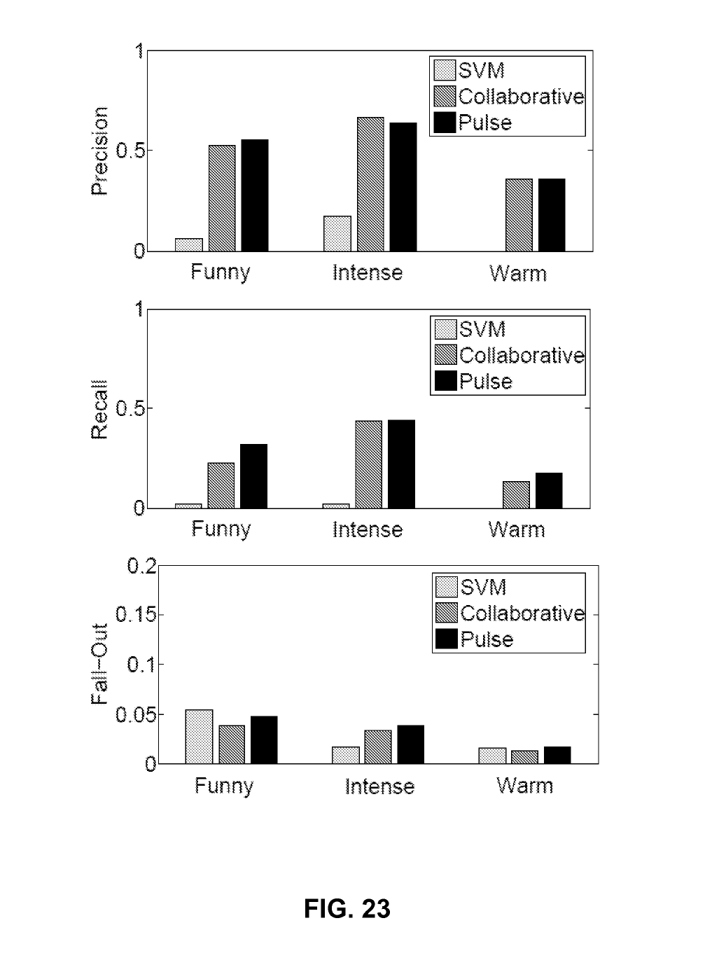

Perception labels can represent a viewer's perception of each movie segment (e.g., warm, intense, funny) The entire vocabulary is shown in Table 2 of FIG. 21B. FIG. 22 shows the performance of perception label prediction for each label, averaged for each user. These labels can be difficult to predict because (1) their corresponding behaviors can be very subtle and implicit and (2) the labels are sparse in the data set. But even for these subtle labels, the example process is able to achieve reasonable average precision 50% and recall 35% with only a minor fallout around 4%. FIG. 23 compares the performance between pure-SVM (using all users' label data as training data with leave-one-video-out cross validation), collaborative filtering and the example process. From top to bottom, the figure shows precision, recall and fallout, respectively. The example process shows substantial improvement over SVM alone and can achieve a higher recall than collaborative filtering.

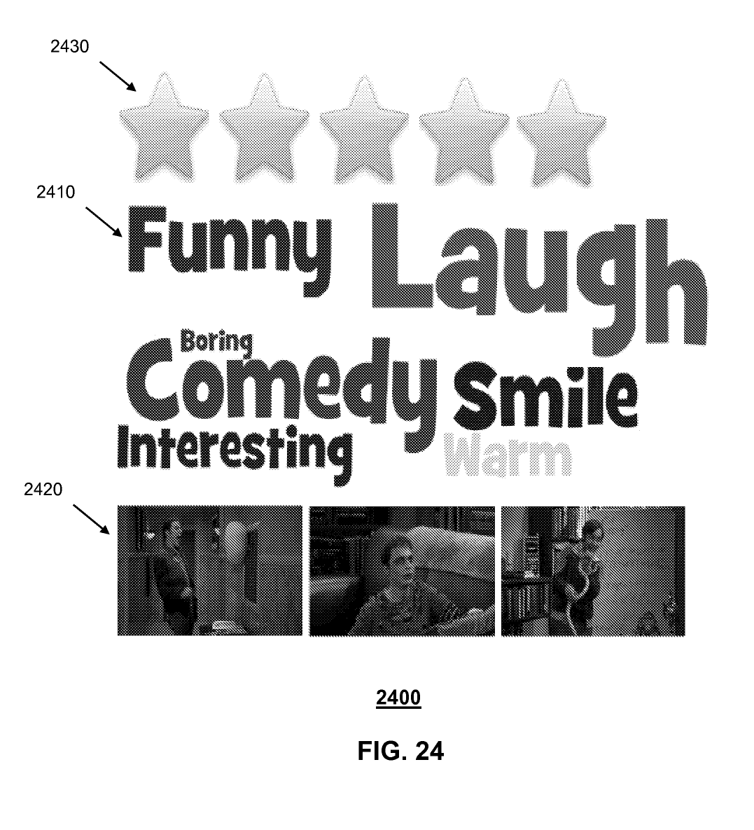

One or more of the exemplary embodiments, can visually summarize the results using a tag cloud. FIG. 24 shows a visualization 2400. The user reaction terms 2410 used within the tag cloud consisted of the different perception and reaction labels and were weighted as follows: (1) movie genre can be included, and the terms interesting and boring can be weighted according to segment ratings; and (2) Reaction labels and perception labels' weight can be normalized by its ratio in this movie relative to its ratio in all movies. Images or video clips 2420 representative of the segments or including the entire segment can be provided along with the final star rating 2430.

One or more of the exemplary embodiments can utilize the large number of sensors on mobile devices, which make them an excellent sensing platform. However, other devices can also be utilized including set top boxes or computing devices that are in communication with one or more sensors, including remote sensors from other devices. Accelerometers can be useful as a measure of a user's motion, or for inferring other information about them. Similarly, microphones can be used for detecting environments, as well as user's reactions. Front-facing cameras enable building on eye detection algorithms used to help track faces in real-time video streams. Combined, these three sensor streams can provide a proxy for intent information, although other sensors and sensor data can be utilized.

Although continuous sensing may offer the highest fidelity, this may cause substantial power drain. In one embodiment, processing can be offloaded to the cloud. In another embodiment, duty cycling can be utilized to save power while also enabling privacy friendly characteristics (e.g., by not sending potentially sensitive data out to the cloud). In this example, the media device can share segment ratings and semantic labels with the cloud to enable other devices to train their personalized models, but the media device can locally retain the sensor data that was used to generate the transmitted ratings and labels.

In one embodiment, annotating of multimedia can be performed by aggregating sensor data across multiple devices as a way of super-sampling. In another embodiment, the aggregating can be across some or all of the users asynchronously. This provides for a privacy friendly approach that also reduces power consumption.

One or more of the exemplary embodiments benefits from the cloud for the computation power, smart scheduling and the crowd's rating information. One or more of the exemplary embodiments can ask users for ratings for a few movies, and then correctly assign new users to a cluster of similar users.

One or more of the exemplary embodiments can use the camera, when the movie is being watched in the dark, to detect the reflections on the iris of the user and to extract some visual cues from it, such as perhaps gaze direction, widening of the eyes, and so forth. In one embodiment, a positive correlation between heart-rate and vibration of headphones can be utilized for inferring user reaction.

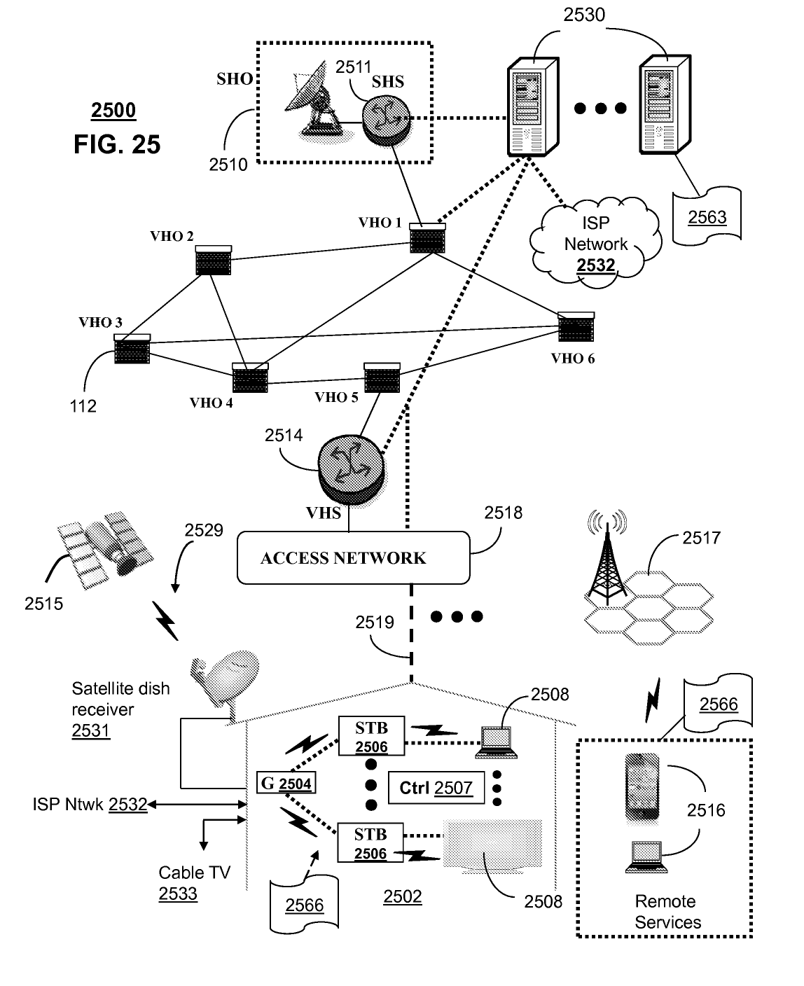

FIG. 25 depicts an illustrative embodiment of a communication system 2500 for delivering media content. The communication system 2500 can deliver media content to media devices that can automatically rate the media content utilizing a personalized model and user reaction data collected by sensors at or in communication with the media device. The communication system 2500 can enable distribution of universal reactions to universal segments of the media content, which allows the media devices to generate personalized models based on the universal reactions in conjunction with the sensed reaction data. The universal reactions can represent user reactions for a particular segment that exhibit correlation and satisfy a threshold, such as a threshold number of user reactions for a segment from different users that indicate the segment is funny The threshold can also be based on other factors, including exceeding a threshold number of user reactions indicating the segment is funny while maintaining under a threshold number of user reactions indicating the segment is boring.

The communication system 2500 can represent an Internet Protocol Television (IPTV) media system. The IPTV media system can include a super head-end office (SHO) 2510 with at least one super headend office server (SHS) 2511 which receives media content from satellite and/or terrestrial communication systems. In the present context, media content can represent, for example, audio content, moving image content such as 2D or 3D videos, video games, virtual reality content, still image content, and combinations thereof. The SHS server 2511 can forward packets associated with the media content to one or more video head-end servers (VHS) 2514 via a network of video head-end offices (VHO) 2512 according to a multicast communication protocol.

The VHS 2514 can distribute multimedia broadcast content via an access network 2518 to commercial and/or residential buildings 2502 housing a gateway 2504 (such as a residential or commercial gateway). The access network 2518 can represent a group of digital subscriber line access multiplexers (DSLAMs) located in a central office or a service area interface that provide broadband services over fiber optical links or copper twisted pairs 2519 to buildings 2502. The gateway 2504 can use communication technology to distribute broadcast signals to media processors 2506 such as Set-Top Boxes (STBs) which in turn present broadcast channels to media devices 2508 such as computers or television sets managed in some instances by a media controller 2507 (such as an infrared or RF remote controller).

The gateway 2504, the media processors 2506, and media devices 2508 can utilize tethered communication technologies (such as coaxial, powerline or phone line wiring) or can operate over a wireless access protocol such as Wireless Fidelity (WiFi), Bluetooth, Zigbee, or other present or next generation local or personal area wireless network technologies. By way of these interfaces, unicast communications can also be invoked between the media processors 2506 and subsystems of the IPTV media system for services such as video-on-demand (VoD), browsing an electronic programming guide (EPG), or other infrastructure services.

A satellite broadcast television system 2529 can be used in the media system of FIG. 25. The satellite broadcast television system can be overlaid, operably coupled with, or replace the IPTV system as another representative embodiment of communication system 2500. In this embodiment, signals transmitted by a satellite 2515 that include media content can be received by a satellite dish receiver 2531 coupled to the building 2502. Modulated signals received by the satellite dish receiver 2531 can be transferred to the media processors 2506 for demodulating, decoding, encoding, and/or distributing broadcast channels to the media devices 2508. The media processors 2506 can be equipped with a broadband port to an Internet Service Provider (ISP) network 2532 to enable interactive services such as VoD and EPG as described above.

In yet another embodiment, an analog or digital cable broadcast distribution system such as cable TV system 2533 can be overlaid, operably coupled with, or replace the IPTV system and/or the satellite TV system as another representative embodiment of communication system 2500. In this embodiment, the cable TV system 2533 can also provide Internet, telephony, and interactive media services.

It is contemplated that the subject disclosure can apply to other present or next generation over-the-air and/or landline media content services system.

Some of the network elements of the IPTV media system can be coupled to one or more computing devices 2530, a portion of which can operate as a web server for providing web portal services over the ISP network 2532 to wireline media devices 2508 or wireless communication devices 2516.

Communication system 2500 can also provide for all or a portion of the computing devices 2530 to function as a server (herein referred to as server 2530). The server 2530 can use computing and communication technology to perform function 2563, which can perform among things, receiving segment ratings and/or semantic labels from different media devices; analyzing the segment ratings and/or semantic labels to determine universal ratings and/or labels for the segments; distribute the universal reactions (e.g., the universal ratings and/or the universal labels) to media devices to enable the media devices to generate personalized user reaction models; analyze monitored behavior associated with the media devices including consumption behavior; and/or generate and distribute duty-cycle instructions to limit the use of sensors by particular media devices to particular portion(s) of the media content instructions (e.g., based on a lack of user reaction data for particular segments or based on monitored user consumption behavior). The media processors 2506 and wireless communication devices 2516 can be provisioned with software functions 2566 to generate personalized models based on received universal reactions; collect reaction data from sensors of or in communication with the device; automatically rate media content based on the personalized model and the sensed user reaction data; and/or utilize the services of server 2530. Software function 2566 can include one or more of RSFE module 250, CLR module 260, EDC module 270 and visualization engine 280 as illustrated in FIG. 2.

It is further contemplated that multiple forms of media services can be offered to media devices over landline technologies such as those described above. Additionally, media services can be offered to media devices by way of a wireless access base station 2517 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies are contemplated by the subject disclosure.

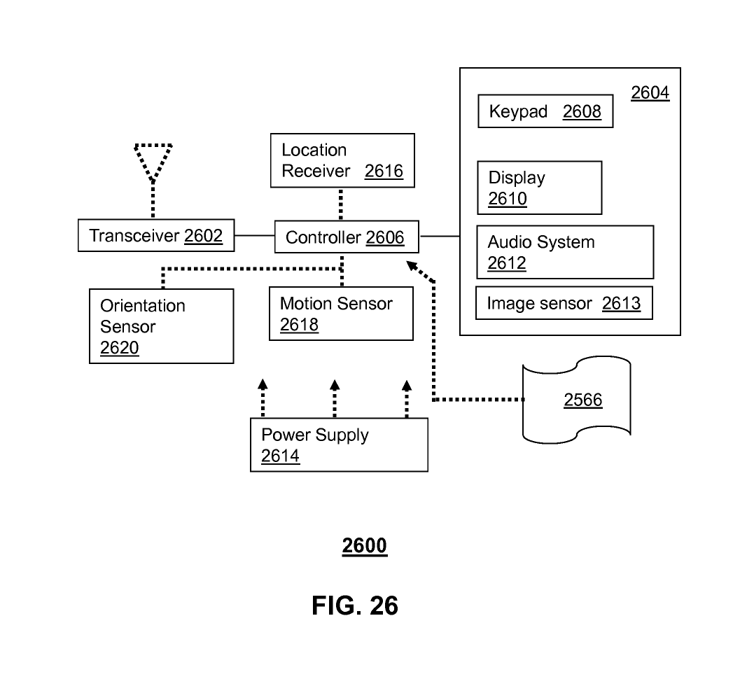

FIG. 26 depicts an illustrative embodiment of a communication device 2600. Communication device 2600 can serve in whole or in part as an illustrative embodiment of the devices depicted or otherwise referred to with respect to FIGS. 1-25. The communication device 2600 can include software functions 166 that enable the communication device to generate personalized models based on received universal reactions; collect reaction data from sensors of or in communication with the device; automatically rate media content based on the personalized model and the sensed user reaction data; and/or utilize the services of server 2530. Software function 2566 can include one or more of RSFE module 250, CLR module 260, EDC module 270 and visualization engine 280 as illustrated in FIG. 2.

The communication device 2600 can comprise a wireline and/or wireless transceiver 2602 (herein transceiver 2602), a user interface (UI) 2604, a power supply 2614, a location receiver 2616, a motion sensor 2618, an orientation sensor 2620, and a controller 2606 for managing operations thereof. The transceiver 2602 can support short-range or long-range wireless access technologies such as Bluetooth, ZigBee, WiFi, DECT, or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 2602 can also be adapted to support circuit-switched wireline access technologies (such as PSTN), packet-switched wireline access technologies (such as TCP/IP, VoIP, etc.), and combinations thereof.

The UI 2604 can include a depressible or touch-sensitive keypad 2608 with a navigation mechanism such as a roller ball, a joystick, a mouse, or a navigation disk for manipulating operations of the communication device 2600. The keypad 2608 can be an integral part of a housing assembly of the communication device 2600 or an independent device operably coupled thereto by a tethered wireline interface (such as a USB cable) or a wireless interface supporting for example Bluetooth. The keypad 2608 can represent a numeric keypad commonly used by phones, and/or a QWERTY keypad with alphanumeric keys. The UI 2604 can further include a display 2610 such as monochrome or color LCD (Liquid Crystal Display), OLED (Organic Light Emitting Diode) or other suitable display technology for conveying images to an end user of the communication device 2600. In an embodiment where the display 2610 is touch-sensitive, a portion or all of the keypad 2608 can be presented by way of the display 2610 with navigation features.

The display 2610 can use touch screen technology to also serve as a user interface for detecting user input (e.g., touch of a user's finger). As a touch screen display, the communication device 2600 can be adapted to present a user interface with graphical user interface (GUI) elements that can be selected by a user with a touch of a finger. The touch screen display 2610 can be equipped with capacitive, resistive or other forms of sensing technology to detect how much surface area of a user's finger has been placed on a portion of the touch screen display. This sensing information can be used control the manipulation of the GUI elements. The display 110 can be an integral part of the housing assembly of the communication device 100 or an independent device communicatively coupled thereto by a tethered wireline interface (such as a cable) or a wireless interface.

The UI 2604 can also include an audio system 2612 that utilizes common audio technology for conveying low volume audio (such as audio heard only in the proximity of a human ear) and high volume audio (such as speakerphone for hands free operation). The audio system 2612 can further include a microphone for receiving audible signals of an end user. The audio system 2612 can also be used for voice recognition applications. The UI 2604 can further include an image sensor 2613 such as a charged coupled device (CCD) camera for capturing still or moving images.

The power supply 2614 can utilize power management technologies such as replaceable and rechargeable batteries, supply regulation technologies, and/or charging system technologies for supplying energy to the components of the communication device 2600 to facilitate long-range or short-range portable applications. Alternatively, the charging system can utilize external power sources such as DC power supplied over a physical interface such as a USB port or other suitable tethering technologies.

The location receiver 2616 can utilize common location technology such as a global positioning system (GPS) receiver capable of assisted GPS for identifying a location of the communication device 2600 based on signals generated by a constellation of GPS satellites, which can be used for facilitating location services such as navigation. The motion sensor 2618 can utilize motion sensing technology such as an accelerometer, a gyroscope, or other suitable motion sensing technology to detect motion of the communication device 2600 in three-dimensional space. The orientation sensor 2620 can utilize orientation sensing technology such as a magnetometer to detect the orientation of the communication device 2600 (north, south, west, and east, as well as combined orientations in degrees, minutes, or other suitable orientation metrics).

The communication device 2600 can use the transceiver 2602 to also determine a proximity to a cellular, WiFi, Bluetooth, or other wireless access points by common sensing techniques such as utilizing a received signal strength indicator (RSSI) and/or a signal time of arrival (TOA) or time of flight (TOF). The controller 2606 can utilize computing technologies such as a microprocessor, a digital signal processor (DSP), and/or a video processor with associated storage memory such as Flash, ROM, RAM, SRAM, DRAM or other storage technologies for executing computer instructions, controlling and processing data supplied by the aforementioned components of the communication system 2500.

Other components not shown in FIG. 26 are contemplated by the exemplary embodiments. For instance, the communication device 2600 can include a reset button (not shown). The reset button can be used to reset the controller 2606 of the communication device 2600. In yet another embodiment, the communication device 2600 can also include a factory default setting button positioned below a small hole in a housing assembly of the communication device 2600 to force the communication device 2600 to re-establish factory settings. In this embodiment, a user can use a protruding object such as a pen or paper clip tip to reach into the hole and depress the default setting button.

The communication device 2600 as described herein can operate with more or less components described in FIG. 26 as depicted by the hash lines. These variant embodiments are contemplated by the subject disclosure.

Upon reviewing the aforementioned embodiments, it would be evident to an artisan with ordinary skill in the art that said embodiments can be modified, reduced, or enhanced without departing from the scope and spirit of the claims described below. For example, in one embodiment, the processing of collected reaction data (e.g., head, lip and/or eye movement depicted in user video; user audio recordings; device movement; trick play usage; user inputs in parallel executed applications at a device, and so forth) can be performed, in whole or in part, at a device other than the collecting device. In one embodiment, this processing can be distributed among different devices associated with the same user, such as a set top box processing data collected by sensors of a television during presentation of the media content on the television, which limits the transmission of the sensor data to within a personal network (e.g., a home network). In another embodiment, remote devices can be utilized for processing all or some of the captured sensor data. In one example, a user can designate types of data that can be processed by remote devices, such as allowing audio recordings to be processed to determine user reactions such as laughter or speech while not allowing images to be processed outside of the collecting device.

In one embodiment, media devices can selectively employ duty-cycle instructions which may be locally generated and/or received from a remote source. The selective use of the duty-cycle instructions can be based on a number of factors, such as the media device determining that it is solely utilizing battery power or a determination that it is receiving power form an external source. Other factors for determining whether to cycle the use of sensors and/or the processing of reaction data can include a current power level, a length of the video content to be presented, power usage anticipated or currently being utilized by parallel executed applications on the device, user preferences, and so forth.

In one embodiment, to facilitate distinguishing between a user's voice and other sounds recorded on the audio recording (e.g., environmental noise or media content audio) a voice sample can be captured and utilized by the device performing the analysis, such as the media device that collected the audio recording during the presentation of the media content.

In one embodiment, reaction models can be generated for each media content that is consumed by the user so that the reaction model can be used for automatically generating content rating for the consumed media content based on collected reaction data. In another embodiment, reaction models for each of the media content being consumed can be generated based in part on previous reaction models and based in part on received universal reactions for universal segments of the new media content. Other embodiments are contemplated by the subject disclosure.

In another embodiment, the power-cycling technique for collecting sensor data can be applied to other processes that require multiple sensory data from mobile devices to be captured during presentation of media content at each of the mobile devices. By limiting one or more of the devices to capturing sensory data during presentation of only a portion of the media content, energy resources for the device(s) can be preserved.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

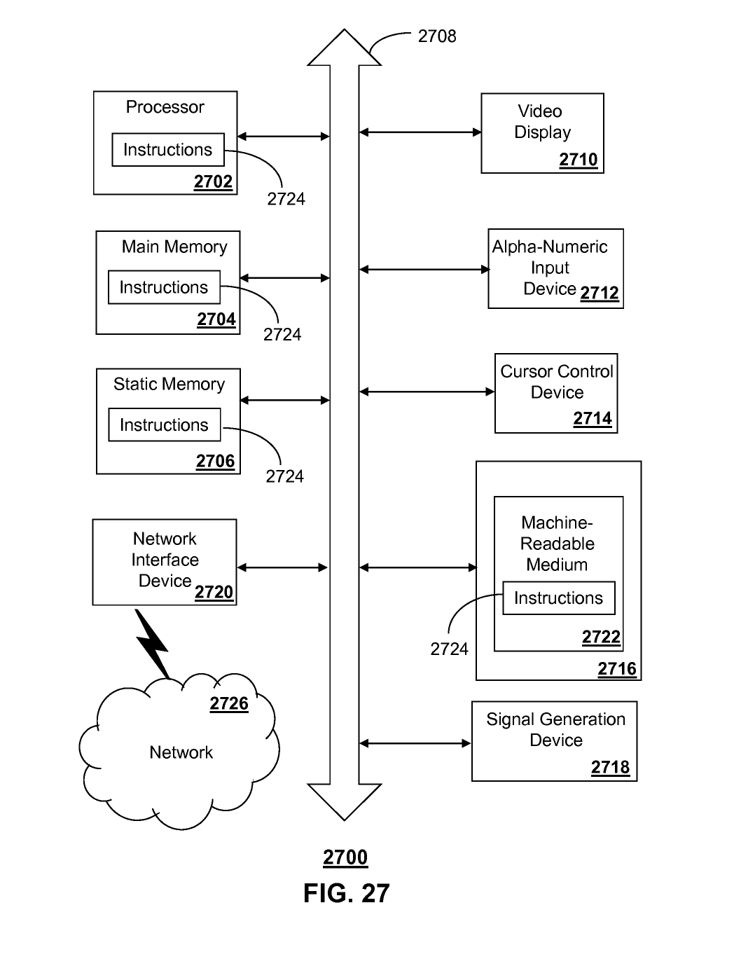

FIG. 27 depicts an exemplary diagrammatic representation of a machine in the form of a computer system 2700 within which a set of instructions, when executed, may cause the machine to perform any one or more of the methods or portions thereof discussed above, including generating personalized models based on received universal reactions; collecting reaction data from sensors of or in communication with the device; automatically rating media content based on the personalized model and the sensed user reaction data; utilizing the services of server 2530; receiving segment ratings and/or semantic labels from different media devices; analyzing the segment ratings and/or semantic labels to determine universal ratings and/or labels for the segments; distributing the universal reactions (e.g., the universal ratings and/or the universal labels) to media devices to enable the media devices to generate personalized user reaction models; analyzing monitored behavior associated with the media devices including consumption behavior; and/or generating and distributing duty-cycle instructions to limit the use of sensors by particular media devices to particular portion(s) of the media content instructions (e.g., based on a lack of user reaction data for particular segments or based on monitored user consumption behavior).

One or more instances of the machine can operate, for example, as the media player 210, the server 2530, the media processor 2506, the mobile devices 2516 and other devices of FIGS. 1-26. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 2700 may include a processor (or controller) 2702 (e.g., a central processing unit (CPU), a graphics processing unit (GPU, or both), a main memory 2704 and a static memory 2706, which communicate with each other via a bus 2708. The computer system 2700 may further include a video display unit 2710 (e.g., a liquid crystal display (LCD), a flat panel, or a solid state display. The computer system 2700 may include an input device 2712 (e.g., a keyboard), a cursor control device 2714 (e.g., a mouse), a disk drive unit 2716, a signal generation device 2718 (e.g., a speaker or remote control) and a network interface device 2720.

The disk drive unit 2716 may include a tangible computer-readable storage medium 2722 on which is stored one or more sets of instructions (e.g., software 2724) embodying any one or more of the methods or functions described herein, including those methods illustrated above. The instructions 2724 may also reside, completely or at least partially, within the main memory 2704, the static memory 2706, and/or within the processor 2702 during execution thereof by the computer system 2700. The main memory 2704 and the processor 2702 also may constitute tangible computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 2722 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA, LTE) are contemplated for use by computer system 2700.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, are contemplated by the subject disclosure. The use of terms including first, second and so on in the claims is to distinguish between elements and, unless expressly stated so, does not imply an order of such element. It should be further understood that more or less of the method steps described herein can be utilized and elements from different embodiments can be combined with each other.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, by a processor of a communication device, an identification of target segments selected from a plurality of segments of media content;
receiving, by the processor, target reactions for the target segments, wherein the target reactions are based on a threshold correlation of reactions captured at other communication devices during the presentation of the media content;
presenting, by the processor, the target segments and remaining segments of the plurality of segments of the media content at a display;
obtaining, by the processor, first reaction data from sensors of the communication device during the presentation of the target segments of the media content, wherein the first reaction data comprises user images and user audio recordings, and wherein the first reaction data is mapped to the target segments;
determining, by the processor, first user reactions for the target segments based on the first reaction data;
generating, by the processor, a reaction model based on the first user reactions and the target reactions;
obtaining, by the processor, second reaction data from the sensors of the communication device during the presentation of the remaining segments of the media content, wherein the second reaction data is mapped to the remaining segments;
determining, by the processor, second user reactions for the remaining segments based on the second reaction data; and
generating, by the processor, segment ratings for the remaining segments based on the second user reactions and the reaction model.

2. The method of claim 1, wherein the user images are utilized to detect head movement, lip movement and eye-lid movement, and wherein the user audio recordings are utilized to detect user speech and user laughter.

3. The method of claim 1, comprising generating, by the processor, semantic labels for the remaining segments based on the second user reactions and the reaction model.

4. The method of claim 1, comprising:
generating, by the processor, segment ratings and semantic labels for the target segments based on the first user reactions;
generating, by the processor, semantic labels for the remaining segments based on the second user reactions and the reaction model; and
generating, by the processor, a content rating for the media content based on the segment ratings for the target and remaining segments and based on the semantic labels for the target and remaining segments.

5. The method of claim 1, comprising:
accessing duty-cycle instructions that indicate a limited portion of the media content consisting of the plurality of segments for which reaction data collection is to be performed.

6. The method of claim 1, comprising:
analyzing the user audio recordings to detect user laughter by comparing audio of the media content with the user audio recordings; and
analyzing the user audio recordings to detect user speech by comparing the audio of the media content with the user audio recordings.

7. The method of claim 1, wherein the first and second reaction data comprise information associated with movement of the communication device.

8. The method of claim 1, wherein the first and second reaction data comprise information associated with trick play utilized at the communication device during the presentation of the plurality of segments of the media content.

9. The method of claim 1, wherein the first and second reaction data comprise information associated with user inputs for another application being executed at the communication device.

10. The method of claim 1, wherein the segment ratings for the remaining segments are generated utilizing Gaussian process regression.

11. The method of claim 1, wherein the target reactions are received by the processor without receiving sensory data captured at the other communication devices and wherein the first reaction data is mapped to the target segments utilizing time stamps.

12. A communication device comprising:
a memory storing computer instructions;
sensors; and
a processor coupled with the memory and the sensors, wherein the processor, responsive to executing the computer instructions, performs operations comprising:
accessing media content;
accessing duty-cycle information that indicate a portion of the media content for which data collection is to be performed;
presenting the media content;
obtaining sensor data utilizing the sensors during presentation of the portion of the media content;
detecting whether the communication device is receiving power from an external source or whether the communication device is receiving the power from only a battery;
obtaining the sensor data utilizing the sensors during presentation of a remaining portion of the media content responsive to a determination that the communication device is receiving the power from the external source; and
ceasing data collection by the sensors during the remaining portion of the media content responsive to a determination that the communication device is receiving the power only from the battery.

13. The communication device of claim 12, wherein the sensor data comprises reaction data that is mapped to the media content, wherein the duty-cycle information comprises instructions received from a remote server, and wherein the processor, responsive to executing the computer instructions, performs operations comprising:
generating segment ratings for the media content based on the reaction data; and
generating a content rating for the media content based on the segment ratings.

14. The communication device of claim 13, wherein the sensors comprise a camera and an audio recorder, and wherein the obtaining of the reaction data comprises:
capturing images of head movement, lip movement and eye-lid movement, and
capturing audio recordings of at least one of user laughter or user speech.

15. The communication device of claim 13, wherein the sensors comprise a motion detector, and wherein the obtaining of the reaction data comprises:
detecting motion of the communication device,
detecting user inputs for another application being executed by the processor, and
detecting trick play inputs for the media content.

16. A non-transitory computer-readable storage medium comprising computer instructions which, responsive to being executed by a processor, cause the processor to perform operations comprising:
receiving segment ratings and semantic labels associated with media content from a group of first communication devices, wherein each of the segment ratings and the semantic labels is mapped to a corresponding segment of a plurality of segments of the media content that were presented on the group of first communication devices;
analyzing the segment ratings and the semantic labels to identify target segments among the plurality of corresponding segments that satisfy a threshold based on common segment ratings and common semantic labels; and
providing target reactions and an identification of the target segments to a second communication device for generation of a content rating for the media content based on the target segments and reaction data collected by sensors of the second communication device, wherein the target reactions correspond to the common segment ratings and the common semantic labels for the target segments.

17. The non-transitory computer-readable storage medium of claim 16, wherein at least some of the segment ratings and the semantic labels are limited to only a portion of the media content, and further comprising computer instructions which, responsive to being executed by a processor, cause the processor to perform operations comprising:
obtaining content consumption information associated with the group of first communication devices;
generating duty-cycle instructions based on the content consumption information; and
transmitting the duty-cycle instructions to the group of first communication devices that indicate the portion of the media content for which the segment ratings and the semantic labels are to be generated.

18. The non-transitory computer-readable storage medium of claim 16, wherein the media content comprises video content, and wherein at least a portion of the group of first communication devices presents the plurality of segments of the media content at different times.

19. The non-transitory computer-readable storage medium of claim 16, wherein at least some of the segment ratings and the semantic labels are limited to only a portion of the media content, and further comprising computer instructions which, responsive to being executed by a processor, cause the processor to perform operations comprising:
obtaining content consumption information associated with a plurality of communication devices;
selecting the group of first communication devices from the plurality of communication devices based on the content consumption information; and
transmitting duty-cycle instructions to the group of first communication devices that indicate the portion of the media content for which the segment ratings and the semantic labels are to be generated.

20. The non-transitory computer-readable storage medium of claim 16, wherein the segment ratings and the semantic labels are received from the group of first communication devices without receiving sensory data from the group of first communication devices.
